(19) United States
(12) Patent Application Publication
(10) Pub. No.: US 2017/0220998 A1
(43) Pub. Date: Aug. 3, 2017

(54) AUTOMATED SERVICE MANAGEMENT SYSTEM WITH RULE-BASED, CASCADING ACTION REQUESTS

(71) Applicants: Gregory William Horn, Lake St. Louis, MO (US); Ryan Owen Denning, West Hartford, CT (US)

(72) Inventors: Gregory William Horn, Lake St. Louis, MO (US); Ryan Owen Denning, West Hartford, CT (US)

(21) Appl. No.: 15/489,078

(22) Filed: Apr. 17, 2017

Related U.S. Application Data
(63) Continuation-in-part of application No. 15/353,663, filed on Nov. 16, 2016.
Application No. 15/353,663 is a continuation of application No. 13/588,576, filed on Aug. 17, 2012, now abandoned.
(60) Provisional application No. 61/659,749, filed on Jun. 14, 2012.

(51) Int. Cl. G06Q 10/10; G06Q 50/00; G06Q 40/08

(52) U.S. Cl. CPC G06Q 10/10; G06Q 40/08; G06Q 50/01

(57) ABSTRACT

A system may generate action requests for a service management system. A user preference data store may contain electronic records for a set of users, including, for example, at least one user preference value. A back-end application computer server may receive, from a remote user mobile device, an indication associated with an event. The server may then determine at least one location coordinate associated with the event and select a sub-set of service providers from a service provider data store based on the location and at least one user preference value. The server may generate an action request for a designated one of the sub-set of service providers in accordance with logic based rules and transmit information about the action request to the designated service provider and the remote user mobile device. The server may receive an action request update and transmit a modified action request to another service provider.

### CROSS-REFERENCE TO RELATED APPLICATIONS

The present application is a continuation-in-part of U.S. patent application Ser. No. 15/353,663 entitled “SYSTEM AND METHOD FOR USE OF SOCIAL NETWORKS TO RESPOND TO INSURANCE RELATED EVENTS” and filed on Nov. 16, 2016, which is a continuation of U.S. patent application Ser. No. 13/588,576 entitled “SYSTEM AND METHOD FOR USE OF SOCIAL NETWORKS TO RESPOND TO INSURANCE RELATED EVENTS” and filed on Aug. 17, 2012, which claimed the benefit of U.S. Provisional Patent Application No. 61/659,749 filed on Jun. 14, 2012. The entire content of those applications are incorporated herein by reference.

### BACKGROUND

In some cases, an enterprise may facilitate a provision of services to a user. For example, an enterprise might coordinate actions performed by service providers to the user in response to an occurrence of an event. Note that many insurance related events require the involvement of one or more service providers to assist in responding to the event. For example, an insured driver who is involved in an automobile accident while far from home may need assistance from several different service providers to deal with the accident, including a tow truck provider, a rental car agency, an automobile repair shop, and a hotel. Often, when an insured driver has such an accident, the driver must either consult their insurance policy to determine what services are covered, call their insurance carrier to file a first notice of loss, and/or keep their receipts and hope that their policy will reimburse the costs of the service providers selected by the insured driver.

Other types of insurance related events require similar levels of involvement. For example, an insured homeowner who suffers damage from a fire may need temporary housing, transportation, clothing, and a contractor to repair the damage. Unfortunately, insured individuals often are unable to quickly contact, interact with, and manage their interactions with service providers that are covered under their insurance policy. Further, individuals who suffered an insurance related event (such as an accident, fire or the like) often are not in a position to contact appropriate service providers. For example, a driver who just suffered a traumatic accident may not necessarily be able (or want) to search for the most appropriate car rental agency.

Further, as consumers become more connected and reliant on the use of social networks to share information about their location, status and activities, they increasingly notify others in their social network of accidents or other events even before they consider contacting their insurance provider. For example, an insured driver who is involved in an accident may immediately publish an update on her Twitter® or Facebook® account notifying those in her social network of the accident.

Moreover, manually coordinating services for a user in response to an occurrence of an event can be a time consuming, costly, and error-prone task—especially where there are a substantial number of service providers and/or events that need to be handled. For example, whenever a service provider changes an action being provided to a user (e.g., by changing when a task is to be started or completed), that change might impact the scheduling of other actions that need to be provided for that particular user. It would therefore be desirable to provide systems and methods to automatically generate action requests for a service management system in a way that results in faster, more efficient performance and that allows for flexibility and effectiveness when coordinating those requests.

### SUMMARY OF THE INVENTION

According to some embodiments, systems, methods, apparatus, computer program code and means to automatically generate action requests for a service management system. In some embodiments, a system may generate action requests for a service management system. A user preference data store may contain electronic records for a set of users, including, for example, at least one user preference value. A back-end application computer server may receive, from a remote user mobile device, an indication associated with an event. The server may then determine at least one location coordinate associated with the event and select a sub-set of service providers from a service provider data store based on the location and at least one user preference value. The server may generate an action request for a designated one of the sub-set of service providers in accordance with logic based rules and transmit information about the action request to the designated service provider and the remote user mobile device. The server may receive an action request update and transmit a modified action request to another service provider.

Some embodiments comprise: means for receiving, at the back-end application computer server from a remote user mobile device associated with a user, an indication associated with an occurrence of an event; means for automatically determining at least one location coordinate associated with the occurrence of the event; means for automatically selecting a sub-set of service providers from a service provider data store based on the location of the event and at least one user preference value in the user preference data store, wherein the user preference data store contains electronic records associated with a set of users, including, for each user, a user identifier, a user communication address, a risk relationship identifier, and at least one user preference value, and the service provider data store contains electronic records associated with a set of service providers, including, for each service provider, a service provider identifier and a service provider communication address; means for generating an action request for a designated one of the sub-set of service providers in accordance with logic based rules; means for transmitting information about the action request to the designated service provider and the remote user mobile device; means for receiving an action request update from the designated service provider; and means for responsive to the action request update, automatically generating and transmitting a modified action request to another service provider in the selected sub-set of service providers. According to some embodiments, the back-end application computer server facilitates an exchange of electronic messages, via a distributed communication network, supporting at least one interactive user interface display associated with the remote user mobile device.

In some embodiments, a communication device associated with a back-end application computer server exchanges information with remote devices (e.g., smartphones, service provider devices, etc.). The information may be exchanged, for example, via public and/or proprietary communication networks.

Technical effects of some embodiments of the invention are improved and computerized ways to automatically generate action requests for a service management system in a way that results in faster, more efficient performance and that allows for flexibility and effectiveness when coordinating those requests. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 is block diagram of a system according to some embodiments of the present invention.

FIG. 3 is block diagram of a system according to some embodiments of the present invention.

FIG. 4 is a flow diagram of a process according to some embodiments of the present invention.

FIG. 5 is a user interface diagram depicting a user interface according to some embodiments of the present invention.

FIGS. 6A and 6B are user interface diagrams depicting further user interfaces according to some embodiments of the present invention.

FIG. 7 is a user interface diagram depicting a claim handler user interface according to some embodiments of the present invention.

FIG. 8A is a high-level block diagram of a system according to some embodiments.

FIG. 8B is a block diagram of a system according to another embodiment.

FIG. 9 illustrates a method according to some embodiments of the present invention.

FIG. 10 is a high-level block diagram of an insurance enterprise system according to some embodiments of the present invention.

FIGS. 11A through 11E illustrate smartphone user displays in accordance with some embodiments.

FIG. 12A illustrates a service provider display that might be associated with various embodiments.

FIG. 12B illustrates an insurance enterprise display that might be associated with various embodiments.

FIG. 13 illustrates a tablet user preferences display in accordance with some embodiments.

FIG. 14 illustrates a tablet service provider preferences display in accordance with some embodiments.

FIG. 15 is a high level system interface architecture according to some embodiments.

FIG. 16 is a block diagram of an apparatus in accordance with some embodiments of the present invention.

FIG. 17 is a portion of a tabular user preference database in accordance with some embodiments.

FIG. 18 is a portion of a tabular service provider database in accordance with some embodiments.

FIG. 19 is a portion of a tabular event database in accordance with some embodiments.

FIG. 20 illustrates an overall insurance enterprise workflow in accordance with some embodiments.

FIG. 21 is an example of a blockchain embodiment according to some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of action request coordination by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks, and subsystems. For example, in the present invention service providers are automatically assigned to react to events taking into account a wide variety of considerations, thus improving the overall performance of the system and reducing response times (e.g., by reducing an overall amount of travel, improving coordination of actions performed by service providers, etc.). Moreover, embodiments associated with automatic prioritizations, assignments, and or action requests will improve communication network performance, user interactions, real time chat or telephone call center responsiveness (e.g., by better preparing and/or allocating service providers in cases of widespread need), etc. The automatic formatting of data as appropriate for various service provider devices will also reduce errors, eliminate the need for unnecessary communications, efficiently distribute information processing between various devices and platforms, etc.

Pursuant to some embodiments, systems, methods, apparatus and computer program code for responding to events, such as insurance related events, are provided. Pursuant to some embodiments, event data associated with an insurance related event are received, and cause the analysis of the event data, the identification of an insured entity and an affected insurance policy, the establishment of a support network for response to the insurance related event, and the communication of information associated with the support network to an insured entity. In some embodiments, the support network is a social network that includes the insured as well as one or more service providers selected based on the affected insurance policy, the insured, and the insurance related event.

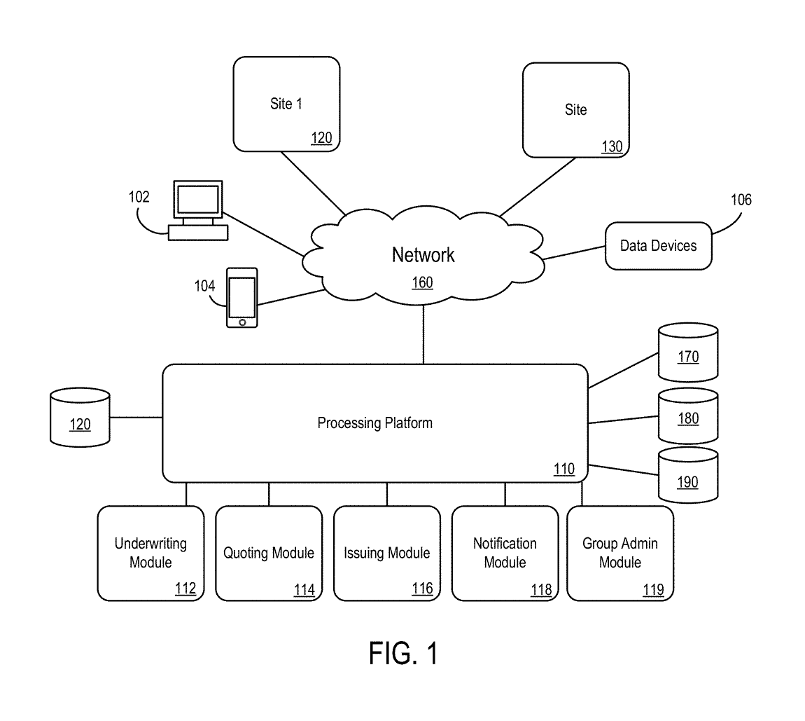

Features of some embodiments will now be described by first referring to FIG. 1 which is a block diagram of an insurance processing platform 100 according to some embodiments of the present invention. The platform 100 may, for example, facilitate the administration of insurance policies using community, social and business network based data such as information published by individuals or businesses (e.g., via Twitter, Facebook, Google+, or the like), as well as information shared by individuals or businesses via applications, memberships, or the like. For illustrative, but not limiting, purposes such information may be published by sites or networks including ebay.com, Facebook.com, LinkedIn.com, Twitter.com, Blogger.com, MySpace.com, Friendster.com, Google+, and other similar sites. Information may also be obtained from applications (such as those provided through the Apple® store, the Android® marketplace or the like) and devices (such as mobile phones, navigation systems, desktop computers or the like). For clarity and ease of exposition, individuals and businesses using features of the present invention to receive insurance services and information may generally be referred to herein as “consumers” or the “insured entity.”

According to some embodiments, an insurance processing platform 110 may be provided for receiving, evaluating, and taking action (such as initiating notifications, making underwriting decisions, issuing policies, etc.) based on social network and other data received from a number of different sources. By way of example only, the insurance processing platform 110 may be associated with and/or communicate with (or receive information about) customers, prospects, or other individuals and entities operating a variety of devices, including, for example, personal computers 102 (including desktop, laptop, tablet, or other types of computers), mobile devices 104 (such as mobile telephones), and other data devices 106 (such as sensors, networked devices, or the like).

The insurance processing platform 110 may, according to some embodiments, operate to perform a number of insurance-related activities, including the administration and support of a number of different types of insurance policies, including personal lines, workers compensation, health, and other commercial policies. Pursuant to some embodiments, insurance processing platform 110 receives data from a wide variety of sources including one or more social media or other websites or properties 120-130 and devices 102, 104, 106. The data received is used to enhance interactions with consumers and insured individuals and businesses. Further, insurance processing platform 110 may transmit data and notifications to consumers and insured individuals and businesses directly to devices 102, 104 or 106 or through one or more social media sites 120-130.

Further, pursuant to some embodiments, insurance processing platform 110 may cause the creation, maintenance, and updating of one or more support networks which are created in response to insurance related events as described herein. Those support networks may be created using platforms such as one or more existing social media sites 120-130. For example, in one illustrative embodiment, an insurance company may use the infrastructure of an existing social network (such as that provided by Facebook® or Google+®) to create private social networks for insured individuals in response to an insurance related event. Such private social networks may be created on a subdomain or other secure area of the existing social network so that the participants in the private social network are limited in a secure and controlled manner. As used herein, the term “support network” or “private social network” is used to refer to a social network created in response to identification of an insurance related event.

As used herein, devices including those associated with the insurance processing platform 110, and any other device described herein may exchange information via any communication network 160 which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Sites 120-130 may store, publish or otherwise provide access to information about consumers. For example, a consumer with a Facebook account may post status updates, information and comments to Facebook, and Facebook may publish or otherwise make the status updates, information or comments available to authorized individuals or entities. In some embodiments, one or more of the sites 120-130 may publish or otherwise disseminate the information via an Application Programming Interface (“API”), an Rich Site Summary (“RSS”) feed, or some other structured format. The information may be analyzed or used by the insurance processing platform 110 on an individual item basis or on an aggregate basis with other information. Further the data may be combined with one or more other data sources, such as publicly available data disseminated by local police or fire authorities, or the like.

As shown, the insurance processing platform 110 may include a number of modules or components, including one or more underwriting modules 112, quoting modules 114, issuing modules 116, notification modules 118 and rules engine 119. Insurance processing platform 110 may be deployed as a number of different platforms in communication with each other (for example, one insurance processing platform may be deployed as an underwriting platform, while another may be deployed to function as a policy issuance platform). Pursuant to the present invention, the notification modules 118 may be used to transmit information to insured individuals, to service providers, and to other entities, including information relating to one or more support networks established pursuant to the present invention. In some embodiments, one or more rules engines 119 may be provided to receive data associated with an insurance related event and determine appropriate actions (including appropriate notifications to be transmitted by notification modules 118, service providers to contact, or the like). In some embodiments, application of rules by the rules engines 119 may result in a First Notice Of Loss (“FNOL”) being generated in response to an insurance related event.

As will be described further below, the underwriting modules 112 may be used in conjunction with the creation and updating of one or more rating schedules for use in pricing and rating insurance policies pursuant to embodiments of the present invention. For example, in some embodiments, the underwriting modules 112 are used to analyze both conventional underwriting data such as historical loss information in conjunction with social and business network based data for use in rating and pricing business insurance policies. Referring still to FIG. 1, the quoting and issuing modules 114 and 116 may be used in conjunction with the quoting, rating and pricing of insurance policies (e.g., in response to requests for quotes received from a mobile device, web server or agents operating agent devices, etc.). Note that the underwriting module 112, quoting module 114, and/or issuing module 116 may be associated with various types of insurance policies, including automobile and home insurance policies, for individuals and/or companies.

Although a single insurance processing platform 110 is shown in FIG. 1, any number of such devices may be included. Moreover, various devices described herein might be combined according to embodiments of the present invention. For example, in some embodiments, the insurance processing platform 110 and modules 112-118 might be co-located and/or may comprise a single apparatus. In some embodiments, some or all of the underwriting analysis may be performed using a spreadsheet based program or other analytic program utilizing one or more servers or server farms in a network based environment.

The insurance processing platform 110 and the modules 112-118 may also access information in one or more databases 170, 180 and 190. The databases may include, for example, risk characteristic data 170, historical loss data 180 associated with previously-issued insurance policies, and policy data 190 associated with active policies. As will be described further below, the policy data 190 may be used to process information associated with insurance related events to identify appropriate service providers and support network features needed to provide support an insured individual.

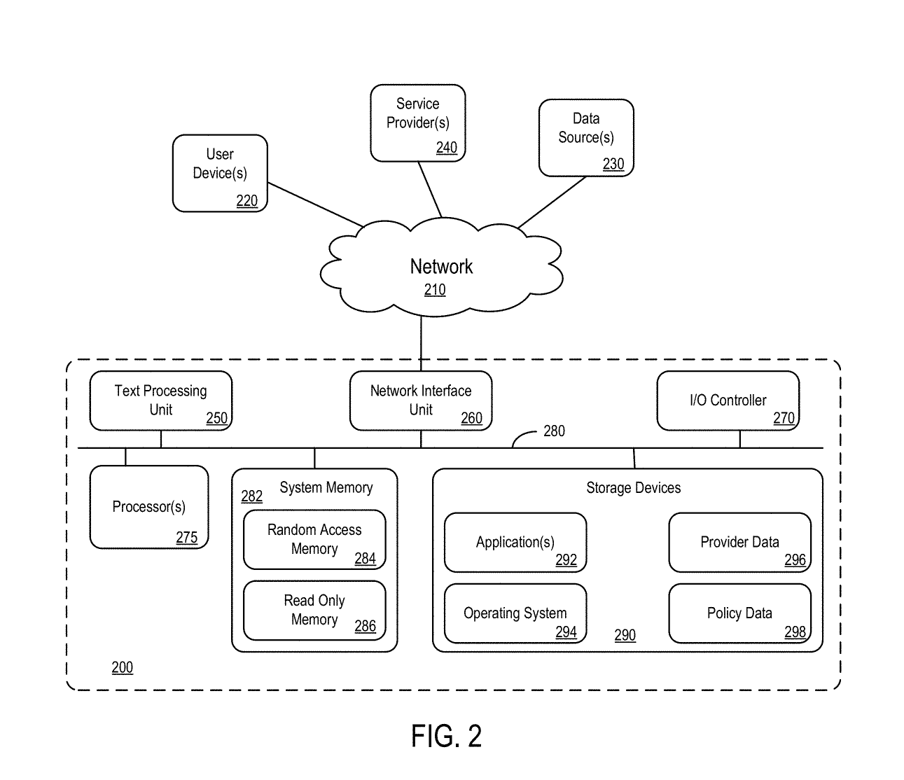

Referring now to FIG. 2, one embodiment of the present invention is shown for utilizing social networks for responding to insurance related events associated with different types of insurance policies. As shown in FIG. 2, the insurance processing platform 200 communicates via network 210 to send data to, and receive data from, a plurality of user devices 220 (such as mobile phones, computers, or the like), a plurality of data sources 230 (such as social networking sites, public data sources, or the like), and a plurality of service provider devices 240 to enable an insurance company to provide quick, appropriate and relevant responses and support to insured entities after insurance related events occur.

Platform 200 also may include a number of devices or components, including computer processor(s) 275 and text processing units 250. The computer processor 275 and the text processing unit 250 may include one or more conventional microprocessors and may operate to execute programmed instructions to provide functionality as described herein. Among other functions, the computer processor 275 and/or the text processor 250 may access and retrieve information from data source(s) 230 via network interface unit 260 and input/output controller 270 via system bus 280.

The insurance processing platform 200 may further include a program memory 282 that is coupled to the computer processor 275. The program memory 282 may include a random access memory 284 and a read only memory 286. System memory 282 is further coupled via bus 280 to one or more fixed storage devices 290, such as one or more hard disk drives, flash memories, tape drives or other similar storage devices. Storage devices 290 may store one or more application programs 292, an operating system 294, and one or more databases such as a provider database 296 for storing data identifying service providers that may be used in conjunction with providing services to insured entities, as well as a policy database 298 for storing data associated with a plurality of insurance policies.

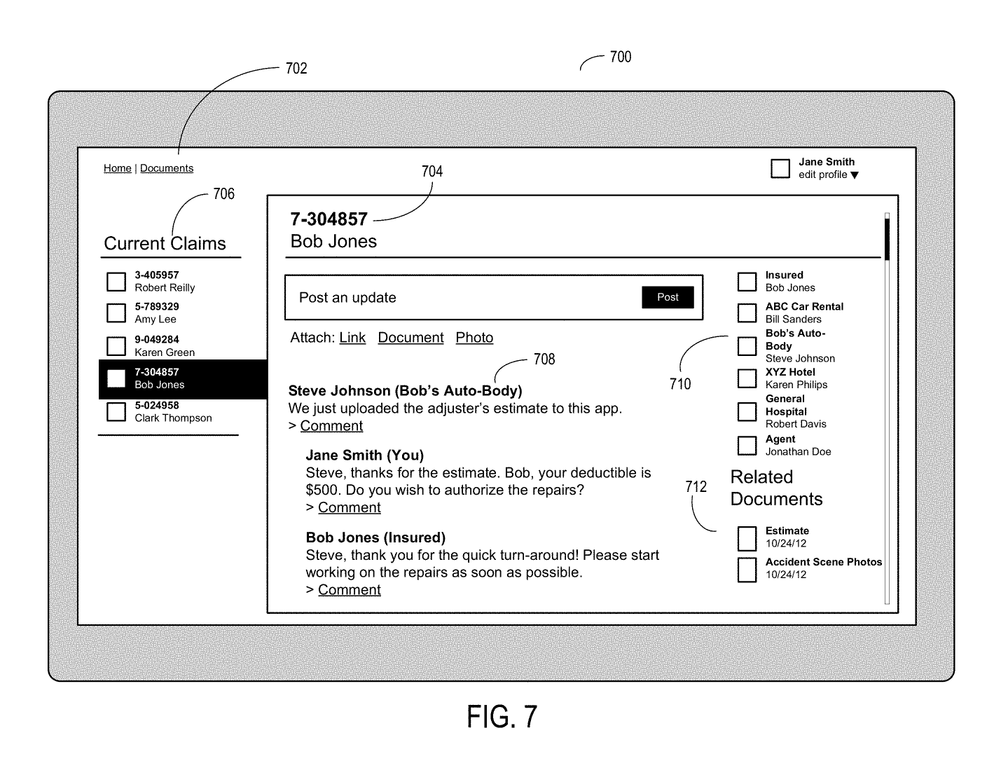

Platform 200 may be, according to some embodiments, accessible via a Graphical User Interface (GUI) rendered at least in part by input/output controller 270. The GUI might be used, for example, to dynamically display information associated with insured entities, policies, and insurance related events. Further, the GUI may be used to display information about one or more private social networks or support networks that have been established in response to one or more insurance related events, allowing a user to view and otherwise interact with the insured entity and one or more service providers associated with the support network. For example, in some embodiments, a user interface such as that shown and described below in conjunction with FIG. 7 may be used by an insurance company claim handler operating a device to display and interact with data associated with the support network.

Referring still to FIG. 2, the platform 200 performs processing to receive, process and extract relevant information from data source(s) 230 (such as social network data). The processing and extraction of information from the data source(s) 230 may take one or more of a number of different forms (as will be described in the various embodiments introduced further below). For example, the processing platform 200 may monitor or search for activity associated with certain known policy holders to identify insurance related events or occurrences in which a policy coverage or benefit may be triggered. As another example, the processing platform 200 may perform actions to verify or validate insurance related events, or to identify one or more relevant service providers that are available to provide support to an insured entity after an insurance related event has occurred. Other examples will be introduced in the embodiments described below. The search and processing of processing platform 200 may involve the use of natural language processing techniques to determine whether certain search, posting, or other activities of consumers contain, in substance, information relevant to insurance related events.

It is contemplated that the processing platform 200 may process data and information in one or more languages, such English, French, Arabic, Spanish, Chinese, German, Japanese and the like. In an exemplary embodiment, underwriting analysis by the platform 200 also can be employed for sophisticated text analyses, wherein text can be recognized irrespective of the text language. The relationships between the various words/phrases can be clarified by using an insurance rules engines for classifying words/phrases as a predictor of certain underwriting risk.

Pursuant to some embodiments, the insurance processing system of the present invention may be used to more proactively offer assistance when policy coverage is triggered. For insured individuals and businesses, insurance coverage provides a hedge against the risk of a loss. The loss typically involves the occurrence of an event, such as an auto accident, a fire, etc. Pursuant to some embodiments, social media and other data sources are used to identify events that involve customers of an insurance company and, based on the customer's policy and the type of event, allow the insurance company to proactively provide assistance, loss remediation services, and other policy benefits. As an example, if an insured is involved in a car accident while on a trip, social media, or other data sources (such as data from an OnStar system, or from the insured's mobile phone) may be monitored so that the insurance company is made aware of the event as it happens (or within a short time of the accident). Then, based on the nature of the event and the insured's policy, the insurance company can proactively provide assistance. For example, an instant private social network or support network may be established for the insured to deal with the event. The instant private social network may be a social circle that connects the insured with one or more service providers that may assist the insured in dealing with the event. For example, the instant network may include car rental agencies, towing services, auto body shops, hotel chains, etc. The insured may interact with others in the group to select and access services and assistance needed to handle the insurance related event.

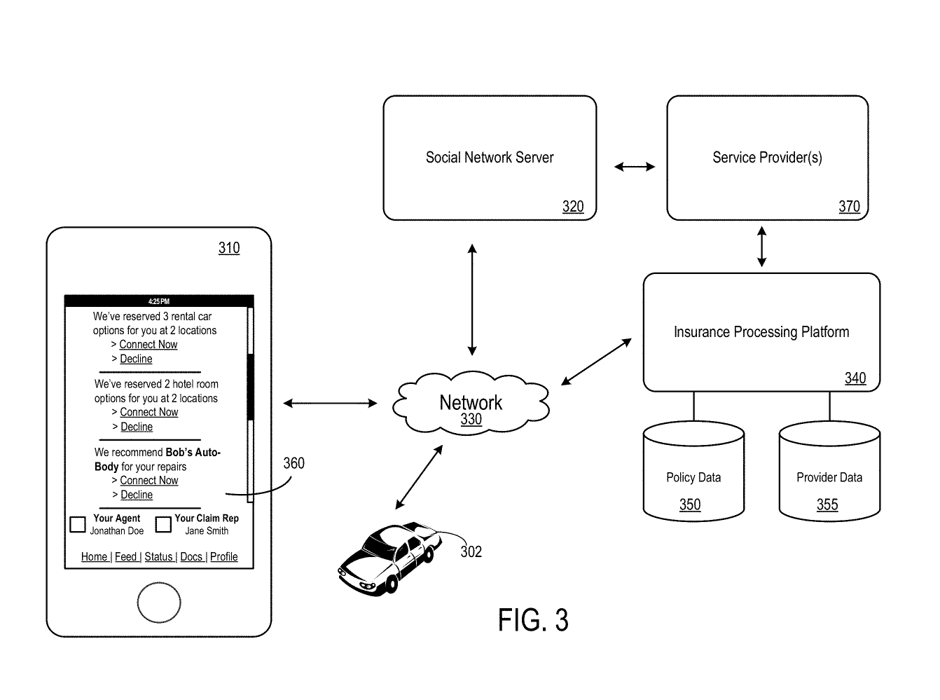

Prior to reference to FIG. 3, in which an illustrative embodiment is shown, a brief illustrative (but not limiting) example will be provided. In the illustrative example, a consumer has an automobile policy issued by an insurance company. The automobile policy includes certain benefits or coverages that are triggered in the event of an automobile accident involving the insured. In the illustrative embodiment, the insurance company operates an insurance processing platform pursuant to the present invention, and allows certain (or all) insured individuals to enjoy proactive policy benefits and assistance pursuant to the present invention. In the example, the insured has chosen to participate in the program, and has registered her mobile device (and installed an insurance benefit application on her mobile device). She has also notified the insurance company of certain social media accounts that she regularly uses (such as, for example, her Twitter feed and her Facebook page). In the example, the insured has also informed the insurance company of her OnStar account information. The insurance company then establishes a monitoring process to monitor those accounts for any information or status updates which may indicate the insured has suffered a loss or accident.

Continuing the example, if the insured is involved in an accident, the insurance company can initiate proactive (and, in some embodiments, automated) policy assistance as soon as an indication of an accident is received (via one or more of the social media accounts, via a phone call, via a text message, via a message from the OnStar system, or the like). Upon receipt of the indication of an accident, the insurance company may initiate one or more automated and substantially immediate proactive steps to assist the insured. For example, a phone connection between an insurance customer service agent and the insured may be initiated. As another example, a support network or support circle may be triggered, which provides a collection of services appropriate to the type of event or incident and the insured's policy benefits. The support network or support circle may include a number of items of information which provide a single source of information for the insured to receive assistance. The support network may remain active and available to the insured for a period of time (such as until a claim resolution has been reached), or may continue as a historical repository of interactions and information between the insurance company and the insured relating to the event. An example of such an embodiment will now be described by reference to FIG. 3.

Reference is now made to FIG. 3, in which an embodiment of a system 300 configured to provide such proactive policy assistance is shown. As shown, system 300 includes a mobile device 310 in communication with a social network server 320 via network 330. Mobile device 310 may be in further communication with an insurance company operating an insurance processing platform 340 pursuant to the present invention. The mobile device 310 is coupled to capture or otherwise receive data and information associated with social network server 320. More particularly, in some embodiments, the mobile device 310 is configured to display information assembled by the social network server 320 in conjunction with data received from the insurance company 340 to provide proactive assistance to a policyholder. For example, the mobile device 310 may display information relevant to the provision of assistance, loss remediation services, and other policy benefits in the event that an insured suffers a loss or other insurance related event. The insurance company 340 operates systems to process, and administer insurance policies based on data received from social network server 320, mobile device 310 and/or from other devices (such as an OnStar or other communication device associated with the insured, such as the insured's automobile 302).

The insurance processing platform 340 may operate one or more rules engines to process data received from the mobile device 310, social network server 320 and/or from other devices to identify the appropriate processing. For example, when an accident occurs involving an insured, data associated with the event are received by the insurance processing platform 340 and used to identify the insured, the associated policy(s) (and the relevant policy form(s)). Key policy status and billing information may also be identified (e.g., by querying a database such as policy database 350). The policy database 350 may store information associated with the insured, the policy forms, the policy status, the covered vehicle(s), the covered driver(s), as well as policy coverages and services. For example, a policy form which provides for immediate roadside assistance, rental car, towing and travel benefits, may result in a different support network than a policy form that only provides for rental car and towing benefits. Application of the rules engine may cause one or more queries of other databases, including databases of service providers 355. For example, if an insured has immediate roadside assistance benefits as a policy feature, application of the rules engine may cause queries of the service provider database 355 to identify one or more roadside assistance service providers that offer service in the geographical area in which the accident occurred. In some embodiments, application of the rules engine may also result in the generation of a FNOL in the insurance processing platform 340.

The mobile device 310 may be any of a number of different types of mobile devices that allow for wireless communication and that may be carried with or by a user. For example, in some embodiments, mobile device 310 is an iPhone® from Apple, Inc., a BlackBerry® from RIM, a mobile phone using the Google Android® operating system, a portable or tablet computer (such as the iPad® from Apple, Inc.), a mobile device operating the Android® operating system or other portable computing device having an ability to communicate wirelessly with a remote entity such as social network server 320 and/or insurance company 340.

The mobile device 310 is configured to display information relating to policy benefits or assistance relating to the insurance related event on a display screen 360. As shown, the insured has been involved in an accident, and the insurance processing platform 340 has initiated a support network for the insured. Information displayed on the display screen 360 may include information associated with the insured's policy, as well as information allowing the insured to immediately take advantage of one or more policy benefits or features. For example, as shown, the insurance processing platform 340 has identified the location of the insured, and has automatically collected information about a number of service providers 370, including car rental agencies, hotels, and other resources available to the insured which are in close geographic proximity to the insured's current location (as determined by geolocation information transmitted from the mobile device 310 and/or the vehicle 302 or other sources). In some embodiments, the resources may be identified from a provider database 355 maintained by or on behalf of the insurance company. In some embodiments, the resources or service providers 370 may be identified using one or more data APIs, such as the Google Places API or the like. In some embodiments, the insured may view details of the resources (such as information about specific hotels, towing companies, auto repair shops, or the like), and may easily initiate contact with the service providers 370. In some embodiments, contact between the resource providers and the insured may be facilitated by the insurance processing platform 340.

Pursuant to some embodiments, varying levels of interaction between the insured entity and service providers 370 may be facilitated. For example, an insured entity who just experienced an automobile accident may want to initiate a call to a tow truck driver (by clicking on a “call” button on a display screen of the mobile device 310), but may want to have one or more repair shops call her the next morning (by selecting an option to schedule a call from the repair shops to her mobile phone the next morning). Further, the insured entity may wish to engage in a three-way call involving an insurance company representative (e.g., by selecting a three-way call option) when discussing repair options with one or more repair shops. Further still, the insured may instead wish to communicate via text messages, emails, or posts in the private social network. In this way, users of mobile devices configured to operate in conjunction with the present invention may receive proactive support in their preferred mode of communication.

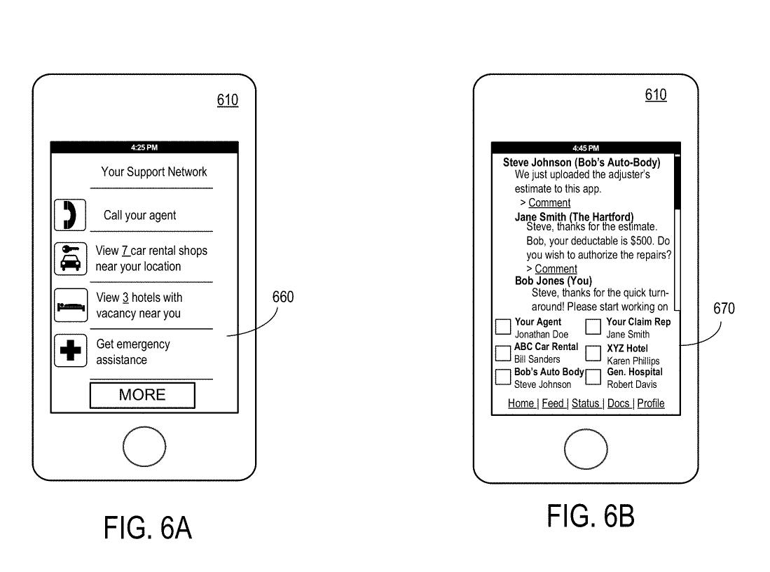

In the user interface depicted in FIG. 3, the mobile device 310 of the insured displays a view of the support network created in response to the accident in which one or more rules have been applied to both identify service providers as well as to initiate transactions with those service providers on behalf of the insured. For example, as depicted, the system has identified that the insured has a policy in which rental car coverage is provided, and the support network has initiated contact with rental car companies and made three different rental car reservations for the insured at two different rental car companies. The insured, operating the mobile device 310, may either decline the options or connect with one or more of the companies to finalize details of the rental. Further, as shown in FIG. 3, application of the rules engine has identified that the insured is eligible for certain hotel benefits (e.g., based on the location of the accident as well as the insured's policy) and two different hotel room options have been reserved. Again, the insured can operate mobile device 310 to finalize the reservation details or decline the options. Those skilled in the art, upon reading this disclosure, will recognize that a wide variety of different services, support features and user interfaces may be provided to insured individuals. For example, in some embodiments, operation of the support network in response to an event may allow the insured to view a list of available service providers, and the insured may review the providers and choose which specific service provider to use. An example of such a user interface is shown in FIG. 6A. In other embodiments, such as the user interface depicted in FIG. 3, operation of the system will automatically initiate reservations with one or more service providers, allowing the insured to simply confirm the reservations.

As a result, insured individuals may receive proactive, and in some instances, substantially instantaneous support and resources from their insurance provider.

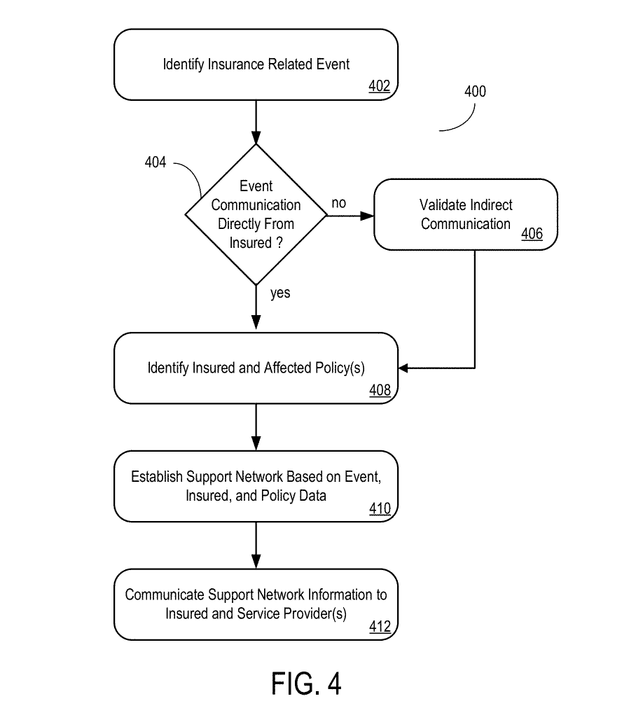

FIG. 4 is a flowchart of a process 400 for establishing an insurance support network pursuant to some embodiments. The process 400 can be performed by the processing platform 110 (as shown in FIG. 1) or a combination of devices as described herein. The process 400 begins at 402 with the identification of an insurance related event. The identification of an insurance related event may involve a number of different types of communications between a user (such as the insured), a device associated with the user (such as an automobile having a communications system such as the OnStar system, a mobile device, a computing device, or the like) which contains a message or information that is either communicated directly to the insurance processing platform 110 (e.g., by a phone call, a text message, a notification from an insurance processing application installed on a mobile device, or the like), or is communicated indirectly to the insurance processing platform 110 (e.g., via a social network message posted by the insured on a social network monitored by the insurance processing platform 110).

At 404, in some embodiments the insurance processing platform 110 determines how the notification of the event was received. For example, if the notification was directly received from the insured, processing continues at 408. If the notification was indirectly received, processing continues at 406 where the indirect communication is validated. Continuing the illustrative example introduced above, the insurance related event may be an automobile accident. The notification of the event may be directly transmitted from the insured to the insurance company (that is, processing at 404 indicates that the event was communicated directly from the insured).

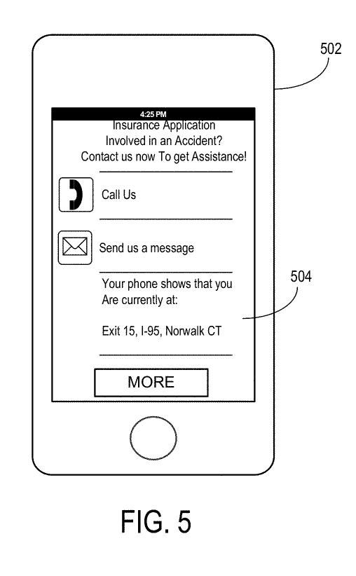

As an example, the insured individual may have a mobile phone that has an insurance processing application installed on it which provides multiple options for communicating the event to the platform 110. In the event that the event notification is transmitted directly to the insurance processing platform 110 (e.g., the insured called, emailed, or otherwise directly notified the insurance company about the event), processing continues at 408 where the insured and any affected policy(s) are identified. An illustrative user interface of such an application is shown in FIG. 5. For example, as shown in FIG. 5, a user has a mobile device 502 which has an insurance processing application installed thereon. The insurance processing application may have been previously installed on the mobile device 502 from an application store such as the Apple iTunes Store, the Android Marketplace, or the like. Pursuant to some embodiments, when the insurance processing application is installed on the mobile device 502, the user may be prompted to enter information about themselves including information identifying their insurance policy(s). The user may also be prompted to specify any contact or communication preferences, as well as emergency contact information. In the event of an accident, the user may launch the insurance processing application on the mobile device 502 and interact with one or more user interfaces 504 to report the event to the insurance company.

For example, as shown in FIG. 5, the user may be presented with one or more contact options which allow quick contact with the insurance company. In some embodiments, the user is also provided with information about their current location (e.g., obtained via geo location resources associated with the mobile device, such as a GPS or cellular location device). In some embodiments, when the user wishes to report the event, information associated with the mobile device 502 and the insurance processing application are automatically transmitted to the insurance processing platform 110 for use in responding to the event. For example, the mobile device 502 may transmit information about the user (including the user's name and policy information) as well as information about the location of the user. Further, in some embodiments, the user may be prompted to provide further information identifying the type of event (such as information specifying that the event is an automobile accident), the severity of the event (whether the automobile is drivable, whether any injuries occurred and the nature of the injuries, whether emergency medical or police assistance is required, and the like).

In some embodiments, an insured (or other individual) may notify the insurance company of an insurance related event indirectly. For example, an insured may post a message or note on a social network which is not necessarily directed solely to the insurance company, but to other individuals and entities as well. As a specific illustrative but not limiting example, an insured who is in an automobile accident may post a status update on her Facebook page notifying her social network of the fact of the accident. Similar updates may be posted on Twitter or other networks. Pursuant to some embodiments, an insurance company operating an insurance processing platform 110 of the present invention may monitor such social networks for updates that suggest that an insurance related event has occurred. The insurance processing platform 110 may execute monitoring processes to monitor the feeds of social networks associated with insured individuals and use natural language processing and other search and text retrieval processes to identify messages (or sets of messages) that suggest an insurance related event has occurred. As an illustrative, but not limiting example, an insured individual who wishes to participate in the system of the present invention may allow the insurance processing platform 110 to monitor specific social network account(s) held by the insured. In some embodiments, the insurance company may be notified of the account(s) when the insured applies for an insurance policy or at a later time.

Pursuant to some embodiments, when the insurance processing platform 110 identifies a possible insurance related event via an indirect communication (e.g., such as via a social media comment or other message), processing may continue at 406 where the indirect communication is validated to ensure that an insurance related event did in fact occur, and that policy benefits and/or assistance are required (or desired) by an insured. The validation of such an indirect communication may occur in any of a number of ways. For example, if a possible insurance related event is identified by monitoring an insured individual's social networking account, and if the insured individual's contact information is known, a phone call may be automatically triggered between a customer service agent and the insured individual so that the customer service agent can verify the event and that policy benefits and/or assistance are required. As another example, a text message, email or the like may be automatically triggered. Processing at 406 may also include validating the indirect communication by obtaining data regarding the event from other sources. As an illustrative example, the insurance processing platform 110 may cause searches to be performed from other data sources to validate the event, such as searches of other social networks for mentions of the event or searches of police or other data sources.

Whether the insurance processing platform identifies an insurance related event as a result of a direct communication from an insured (e.g., via processing at 402, 404) or as a result of an indirect communication from an insured (e.g., via processing at 402, 406), processing continues at 408 where the processing platform identifies the insured and any affected policy(s). In the case where the insured is operating a mobile device having an insurance processing application thereon, information identifying the insured and the insured's policy(s) may be provided as a direct message or interaction between the mobile device and the insurance processing platform (e.g., information identifying the insured and the policy(s) may be stored in the application or accessible via interacting with the application). In other situations, the identification may be inferred from information associated with the information identifying the event (e.g., if an insurance related event is identified by monitoring an insured's Twitter account, the insured's identity and related policies may be looked up based on the Twitter account information).

Once the insured and related policy(s) are identified, processing continues at 410 where the insurance processing platform causes a private social network or support network to be established for use by the insured. The private social network may be automatically created and populated with information associated with the insured's policy data, as well as information about the location of the event and the nature of the event. For example, if the insured is in an auto accident in Norwalk Conn., and the insured lives in Topeka Kans., the private social network may be created with information about relevant service providers in the Norwalk Conn. area. In some embodiments, the relevant service providers are determined based on a set of known or approved providers. In some embodiments, some or all of the relevant service providers are determined based on location and relevance. In some embodiments, the service providers may further be ranked based on user feedback, satisfaction ratings, or the like. Each of the identified service providers, as well as the insured (and one or more customer support specialists) are identified as participants in the support network and are allowed to interact with each other through the support network.

In some embodiments, the creation of the support network is based on the application of one or more rules (e.g., from rules engine 119 of FIG. 1) which are applied based on the nature of the event, the insured's policy information, and other information. As an example, in the case of an auto accident, an accident rules engine may be applied which analyzes data and ensures the appropriate communications are made to the insured as well as to any service providers needed to respond to the accident. In some embodiments, the application of the rules engine may result in the creation of a FNOL on behalf of the insured. Examples of rules applied by the rules engine may include accident criteria or characteristics, geolocation, preferred or approved repair shops, rental car agencies, emergency services, hotel accommodations, towing information (company, if covered), other towing services (if not covered), whether authorities were contacted, and the like.

In some embodiments, if the accident involves other parties (e.g., in the case of a multi-vehicle accident), once information associated with the other parties is obtained (e.g., from the insured operating a mobile device, or from a claims handler), the other parties may be allowed to receive services through the support network as well. For example, a driver of the other vehicle involved in an accident may be eligible to receive roadside assistance, rental car, hotel or other services and may be prompted to download an insurance application onto their mobile device or access a support network from a personal computer or the like.

Once the support network has been created, processing continues at 412 where information about the support network is communicated to each of the participants, including, for example, the insured, the customer support specialist(s), and the identified service providers. The information communicated may include instructions for accessing the network (including user names and passwords) as well as information identifying the nature of the insurance event that the network has been establish to support. Third parties (such as other drivers involved in a multi-vehicle accident, for example) may also receive information to participate in the support network.

Once a support network has been established in response to an event, a number of participants may easily interact with each other to resolve issues associated with the event. For example, referring now to FIG. 6B, the insured may view and interact with the support network using a mobile device 610 (or other computing devices) and interact with other parties, such as the assigned claim representative or handler, the agent, rental car companies, towing companies, repair companies, or the like. As depicted in FIG. 6B, a comment or message stream may be displayed, allowing easy communication between the insured and other participants in the support network.

Other parties in the support network are also able to easily communicate using the present invention. For example, referring now to FIG. 7, insurance company representatives (such as claim handlers) may interact with the support network and other participants using a user interface 700 displayed on a device 702 such as a personal computer, mobile device, or a tablet computer. As depicted in FIG. 7, a claims handler may have the ability to interact with and work on a number of current claims 706. Each claim 706 may be associated with a separate support network that has been established pursuant to the present invention. As shown, a claims handler (“Jane Smith”) is interacting with a support network associated with a claim made by “Bob Jones”. Information associated with the current claim file 704 may be displayed for ease of reference by the claims handler, as well as a message stream 708 of comments or messages between individuals and entities within the support network that has been established for the current claim file 704. In some embodiments, the message stream 708 may be displayed as a threaded stream of messages, grouping comments, messages and replies to comments or messages together. The message stream 708 may include all messages or interactions between the participants of the support network and may be stored or archived as part of an insurance claim file for future use.

As depicted, a list of the participants in the support network for the current claim file 704 are shown at 710, and the claims handler may message any or all of the participants directly from the user interface. A set of related documents or materials may also be provided at 712. In this manner, a claims handler may easily interact with a number of claims and participate in a number of support networks to resolve issues and provide service and support. Those skilled in the art will appreciate that the user interface 700 may be presented in other layouts, with additional (or different) items of information, and that the specific layout and data shown in FIG. 7 is for illustrative, but not limiting, purposes.

Similar user interfaces may be provided for service providers participating in a support network of the present invention. For example, a service provider such as “Bob's Auto-Body” that has been identified as participating in a support network to resolve claim “7-304857” may be presented with a user interface that allows the service provider to view certain messages associated with their interactions with the claim handler and the insured. In some embodiments the permissions associated with each service provider may be set by a rules engine or by a claims handler to ensure that service providers are able to only access information relevant to their provision of services.

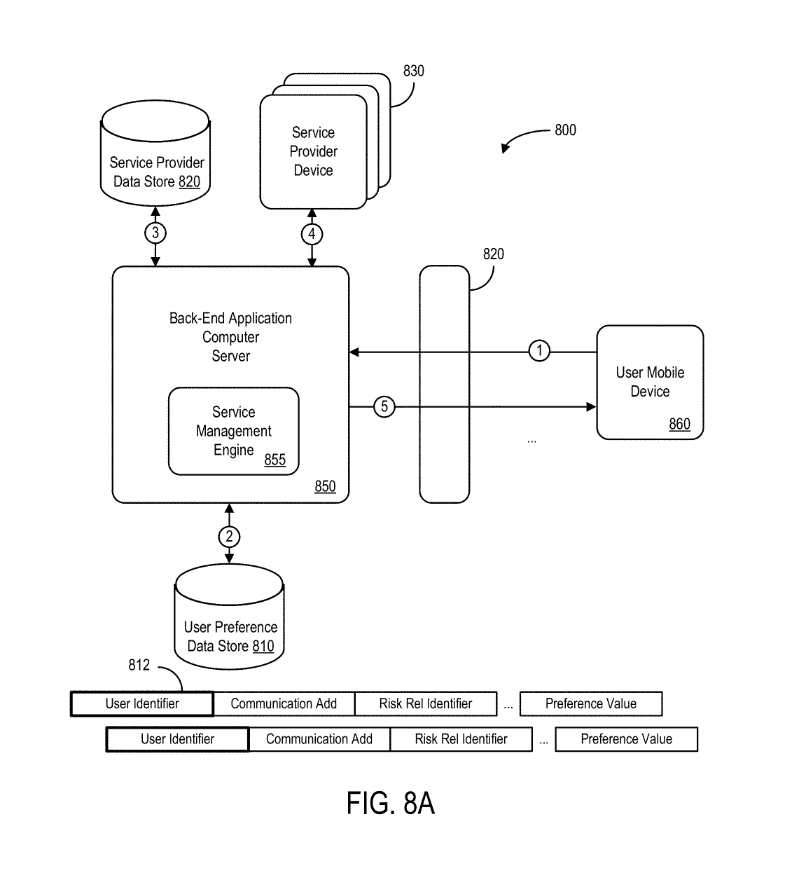

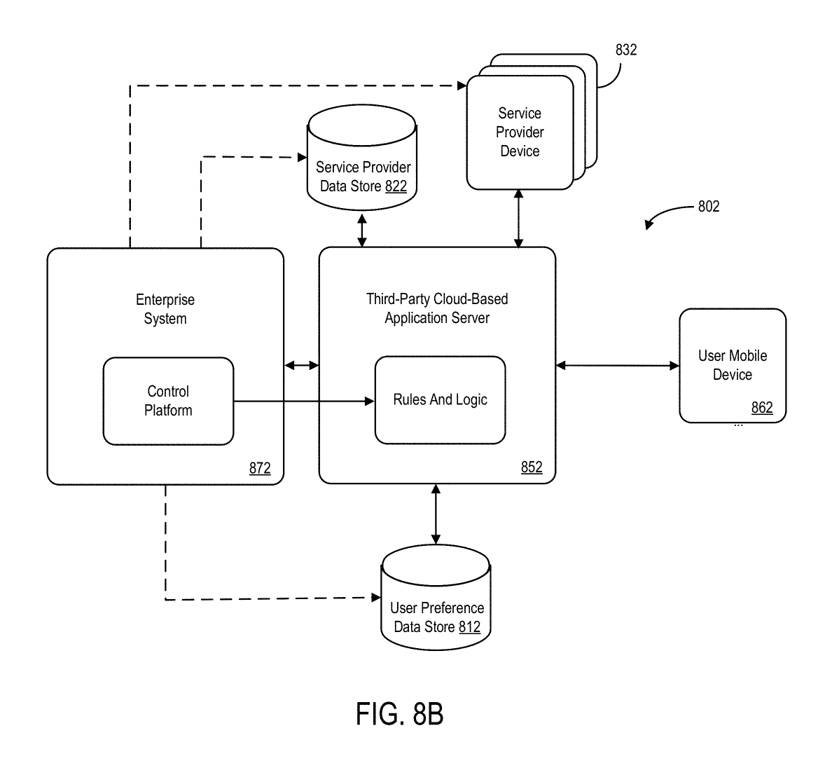

FIG. 8A is a high-level block diagram of a system 800 according to some embodiments of the present invention. In particular, the system 800 includes a back-end application computer server 850 that may access information in a user preference data store 810 (e.g., storing a set of electronic records representing a user identifier, communication address, risk relationship identifier, one or more user preference values, etc.). The back-end application computer server 850 may also exchange information with a remote user mobile device 860 (e.g., via a firewall 820). According to some embodiments, a service management engine 855 of the back-end application computer server 850 may access information in a service provider data store 820 (e.g., including information about various service providers that may perform actions on behalf of users), generate and/or modify action requests, and transmit indications of those action requests to service provider devices 830 and/or the remote user mobile device 860. Note that embodiments may be associated with periodic (or asynchronous) types of prioritization, assignment, and/or scheduling. Further note that the back-end application computer server 850 might be associated with a third party, such as a vendor that performs a service for an enterprise.

The back-end application computer server 850 might be, for example, associated with a Personal Computer (“PC”), laptop computer, smartphone, an enterprise server, a server farm, and/or a database or similar storage devices. According to some embodiments, an “automated” back-end application computer server 850 may automatically generate action requests based on information in the user preference data store 810. As used herein, the term “automated” may refer to, for example, actions that can be performed with little (or no) intervention by a human.

As used herein, devices, including those associated with the back-end application computer server 850 and any other device described herein may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet. Note that any devices described herein may communicate via one or more such communication networks.

The back-end application computer server 850 may store information into and/or retrieve information from the user preference data store 810 and/or the service provider data store 820. The data stores 810, 820 may be locally stored or reside remote from the back-end application computer server 850. As will be described further below, the user preference data store 810 may be used by the back-end application computer server 850 to automatically prioritize and/or generate action requests for a service management system. Although a single back-end application computer server 850 is shown in FIG. 8A, any number of such devices may be included. Moreover, various devices described herein might be combined according to embodiments of the present invention. For example, in some embodiments, the back-end application computer server 850, user preference data store 810, and/or service provider data store 820 might be co-located and/or may comprise a single apparatus.

According to some embodiments, the system 800 may automatically prioritize, generate and/or modify action requests for service providers via the automated back-end application computer server 850. For example, at (1) the remote user mobile device 860 may indicate that an event has occurred (e.g., a user may have been involved in an automobile accident). At (2), the back-end application computer server 850 may access preference from the user preference data store 810 (e.g., indications that a particular user prefers to utilize a specific rental car company or hotel). At (3), the service management engine 855 may access information in the service provider data store 820 and select a sub-set of service providers (e.g., based on location information and user preference data), and actions requests may be generated and transmitted to service provider devices 830 at (4) and/or the remote user mobile device 860 at (5).

FIG. 8B is a block diagram of a system 802 according to another embodiment. In this example, the system 802 includes a third-party cloud-based application server 852 that may operate under the direction and/or control of an enterprise system 872 (e.g., associated with an insurer). The third-party cloud-based application server 852 may access information in a user preference data store 810 (e.g., storing a set of electronic records representing a user identifier, communication address, risk relationship identifier, one or more user preference values, etc.) and exchange information with a remote user mobile device 862. According to some embodiments, rules and logic of the third-party cloud-based application server 852 may access information in a service provider data store 822 (e.g., including information about various service providers that may perform actions on behalf of users), generate and/or modify action requests, and transmit indications of those action requests to service provider devices 832 and/or the remote user mobile device 862.

According to some embodiments, the system 802 may automatically prioritize, generate and/or modify action requests for service providers via the third-party cloud-based application server 852. For example, the remote user mobile device 862 may indicate that an event has occurred, and the third-party cloud-based application server 852 may access preference from the user preference data store 812. The rules and logic may access information in the service provider data store 822, select a sub-set of service providers, and generate actions requests to be transmitted to service provider devices 832.

Note that the third-party cloud-based application server 852 might handle the majority of interactions with users and simply report service results back to the enterprise system 872. In some cases, the enterprise system 872 may have a control platform that provides the rules and logic to the third-party cloud-based application server 852. The control platform may, for example, establish a conditional sequence of events that should be performed in response to an event. The enterprise system 872 might also directly load data into the user preference data store 812 (e.g., information that is determined when an insured purchases an insurance policy) and/or the service provider data store 822 (e.g., when a network of service providers is initially established). The enterprise system 872 might also communicate directly with the service provider devices 832, such as to arrange for payments in exchange for provided services, to evaluate service provider performance, to audit services that were provided in response to an event or group of events, etc.

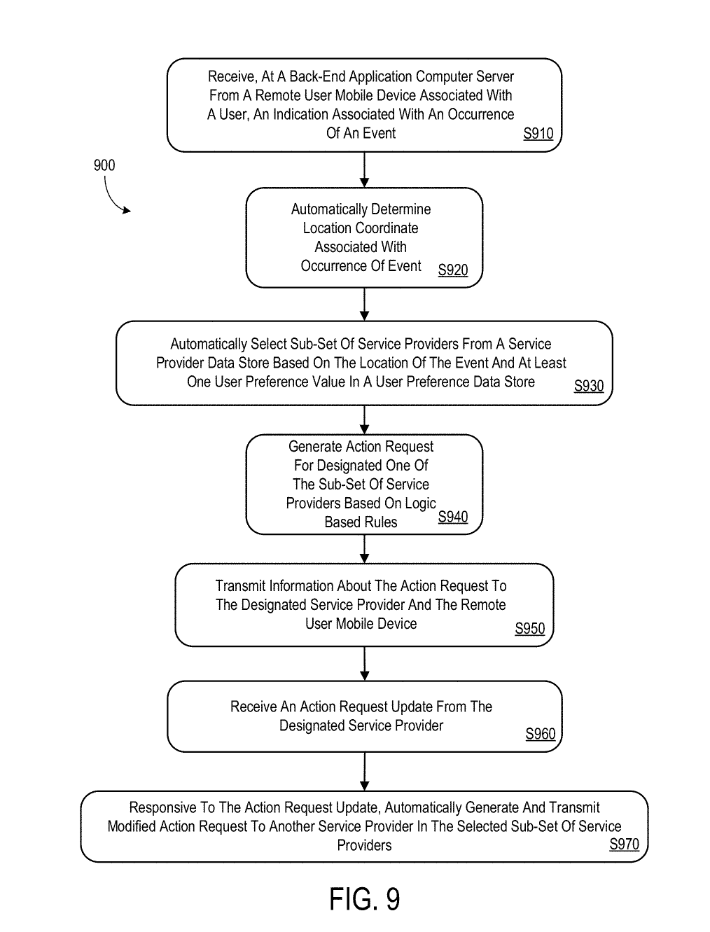

Note that the system 800 of FIG. 8A and the system 802 of FIG. 8B are provided only as examples, and embodiments may be associated with additional elements or components. According to some embodiments, the elements of the systems 800, 802 automatically support interactive user interface displays over a distributed communication network. For example, FIG. 9 illustrates a method 900 that might be performed by some or all of the elements of the systems 800, 802 described with respect to FIGS. 8A and 8B, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S910, a back-end application computer server may receive, from a remote user mobile device associated with a user, an indication associated with an occurrence of an event. As used herein, the phrase “user mobile device” might refer to, for example, a smartphone, a mobile computer, a tablet computer, an on-board vehicle diagnosis plug-in device, a built-in dashboard display, a flying drone, a self-driving vehicle, a smart watch, a pair of smart eyeglasses, an augmented reality device, an Internet of Things (“IoT”) device, a health monitoring device, a network-connected device able to approximate and report a current location, etc. Note that an enterprise might dynamically collect information about events via an email received by an email server, a text message, information provided a web interface, an Interactive Voice Response (“IVR”) system associated with a telephone call center, a chat application that interacts with a party in substantially real time, a video link, etc.

At S920, the system may automatically determine at least one location coordinate associated with the occurrence of the event. As used herein, the phrase “location coordinate” might refer to, for example, a postal address, a ZIP code, Global Positioning System (“GPS”) information, latitude and longitude values, mobile telephone location data, etc.

At S930, the system may automatically select a sub-set of service providers (e.g., associated with automobile towing, automobile repair, a transportation service, a dynamic, on-demand transportation platform such as Uber®, a transportation sharing service, automobile rental, lodging, etc.) from a service provider data store based on the location of the event and at least one user preference value in the user preference data store. According to some embodiments, the user preference data store contains electronic records associated with a set of users, including, for each user, a user identifier, a user communication address (e.g., a mobile telephone number, a vehicle identifier, a user identifier, an IP address, a device identifier associated with a push message registration, etc.), a risk relationship identifier, and at least one user preference value (e.g., a preferred service provider type, a preferred response to an event, historical user data associated with the user, historical user data associated with other users, etc.).

Similarly, the service provider data store may contain electronic records associated with a set of service providers, including, for each service provider, a service provider identifier and a service provider communication address. According to some embodiments, the service provider data store further stores, for each service provider, at least one service provider preference value and the selection of the sub-set of service providers is further based on service provider preference values. Note that the selected sub-set of service providers might be calculated using, for example, distance information, time information (e.g., how long it will take a service provider to reach the location where the event occurred), real-time traffic information, weather information, speed limit information, jurisdiction information (e.g., only an in-state service provider might be selected), and/or current service provider location information.

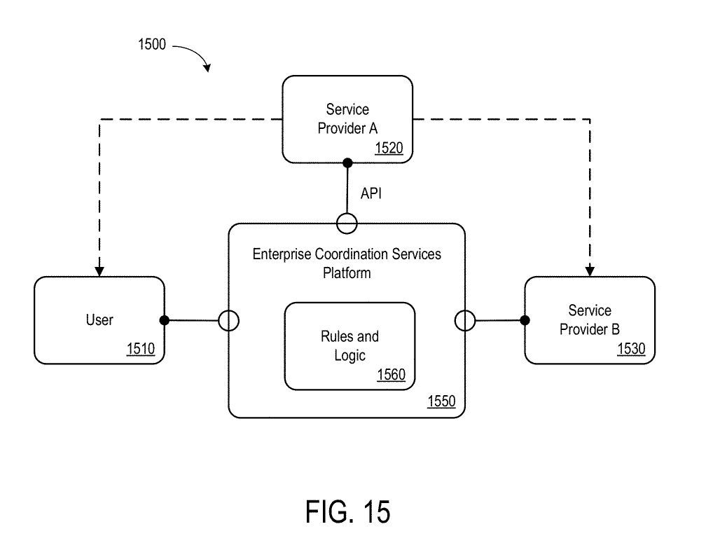

At S940, the back-end application computer server may generate an action request for a “designated” one of the sub-set of service providers in accordance with “logic based rules.” As used herein, the phrase “logic based rules” might refer to, for example, conditional rules, dynamic rules, automatically created rules, user-defined rules, sequences of actions (e.g., branching in various directions based on conditions), etc. Note that the “designated” service provider might be selected by the user from the sub-set of service providers. According to some embodiments, each service provider is associated with a service provider type and the occurrence of the event results in multiple service providers, of different types, being designated (e.g., a towing service, repair shop, and hotel might all be designated in response to a single event). According to some embodiments, the action request may be formatted in accordance with an Application Programming Interface (“API”) protocol. More information about the use of an API according to some embodiments is provided in connection with FIG. 15.

At S950, the system may transmit information about the action request to the designated service provider (e.g., via the API protocol) and to the remote user mobile device. At S960, the back-end application computer server may receive an action request update from the designated service provider. For example, a repair shop might indicate that a repair will take three days to complete instead of a previously predicted two days. At S970, responsive to the action request update, the system may automatically generate and transmit a modified action request to another service provider in the selected sub-set of service providers. For example, the system might automatically update a hotel reservation from two nights to three nights in response to an action request update.

Note that receipt of an action request update might cascade to create multiple modified action requests that are transmitted to multiple service providers. For example, a towing service indication that arrival at the scene of an accident will be delayed by two hours might automatically update information at an automobile repair shop, a taxi service, a hotel reservation, etc. According to some embodiments, a back-end application computer server is further programmed to interface with a user's calendar application and to calculate an estimated time in connection with at least one service provider. For example, the server might interface with a user's smartphone calendar to automatic generate reminders, alerts, etc. According to some embodiments, the back-end application computer server is further to receive, from at least one service provider device, insurance claim information such as text comprising insurance claim notes, images, audio information, video information, environmental quality information, weather information, etc.

According to some embodiments, the back-end application computer server is further to receive from the user rating information about at least one service provider. For example, each client might indicate whether or not he or she was satisfied with the service performed by a hotel. In this case, after insurance claims are resolved, the back-end application computer server may periodically monitor performance outcomes and automatically adjust a prioritization algorithm used to select the sub-set of service providers. Note that each insurance claim may be associated with an event, and the back-end application server may access pre-event insurance policy information, transmit the pre-event insurance policy insurance information to the designated service provider, and receive, from the designated service provider, post-event data associated with damage caused by the event.

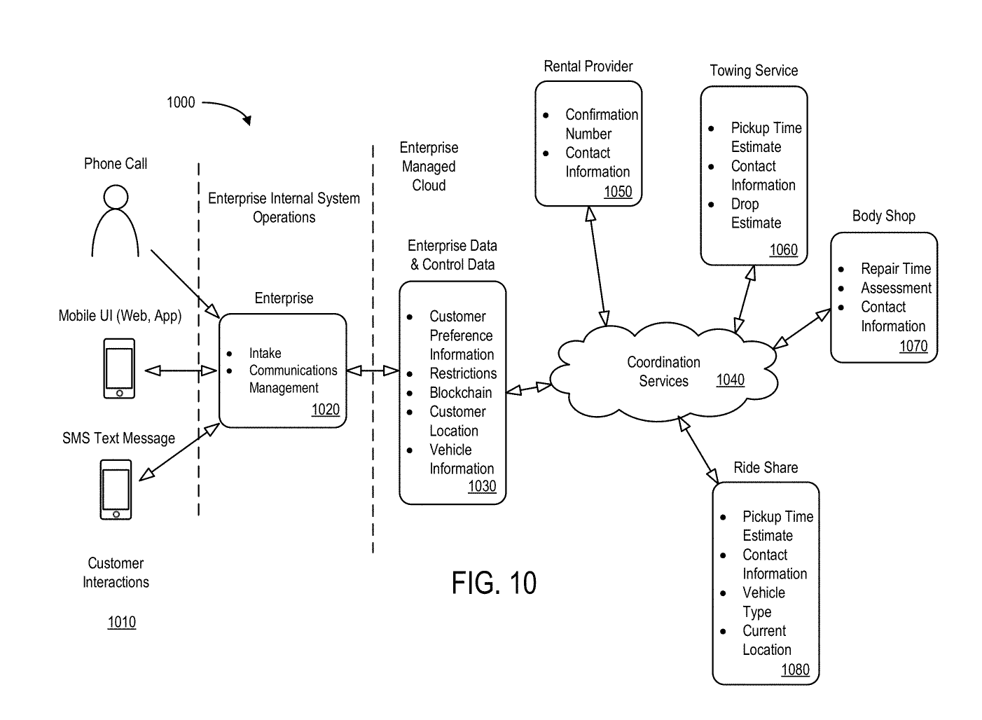

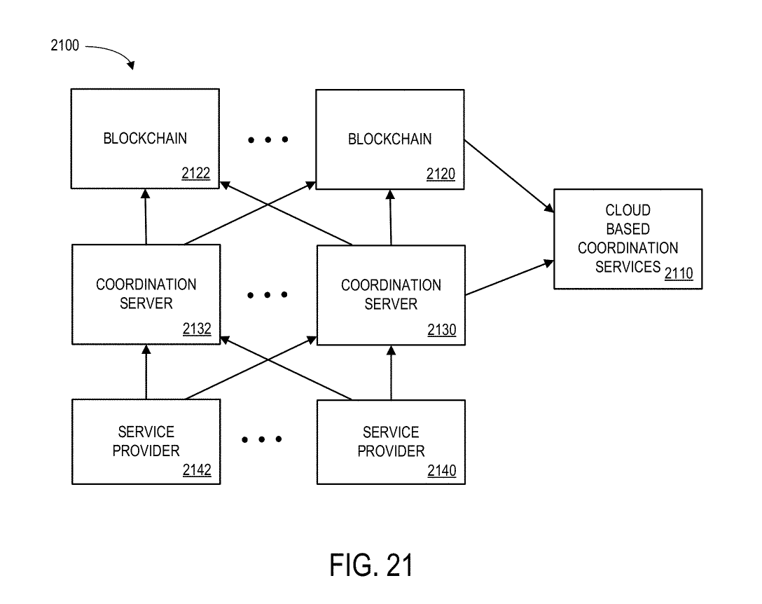

FIG. 10 is a high-level block diagram of an insurance enterprise system 1000 including customer interactions 1010 in which a telephone call, mobile User Interface (“UI”), web site, smartphone application, Short Message Service (“SMS”), etc. may be used to report an event to an enterprise 1020. For example, a user might report an automobile breakdown or accident to intake and/or communications management function of internal system operations run by the enterprise 1020. The enterprise 1020 may interact with an enterprise data and control data platform 1030 to provide coordination services 1040 for the system 1000. The enterprise data and control data platform 1030 might, for example, handle customer preference information, restrictions, blockchain validation (as described with respect to FIG. 21), customer location detection, and/or vehicle information functions.

The coordination services 1040 may then synchronize actions performed by various service providers. For example, the coordination services 1040 might interface with: a rental provider 1050 (confirmation numbers, contact information); a towing service 1060 (a pickup Estimated Time of Arrival (“ETA”), contact information, drop estimate); a body shop 1070 (repair time, damage assessment, contact information, a ride share service 1080 (a pickup ETA, contact information, vehicle type, current location), etc. Further details about the operation of the coordination services 1040 according to some embodiments are provided with respect to FIG. 15.

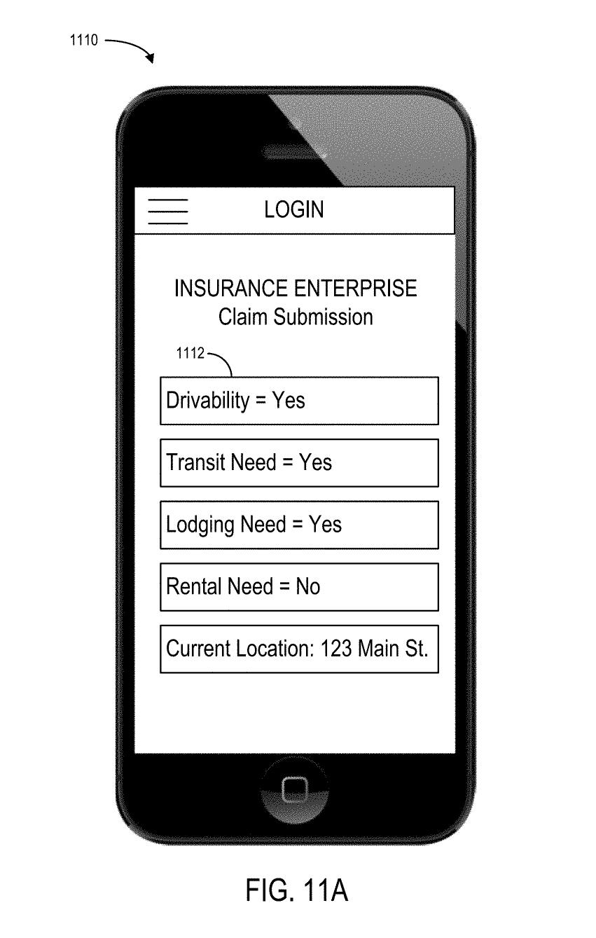

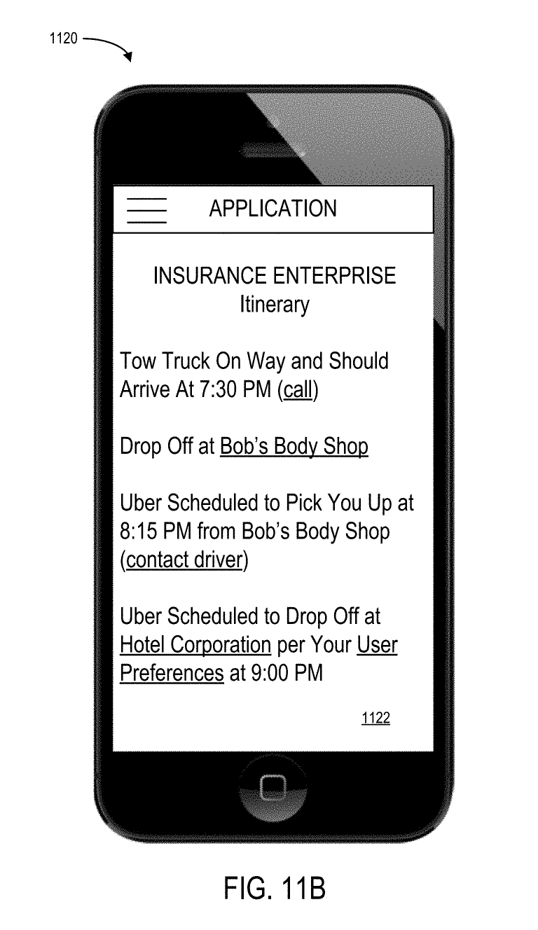

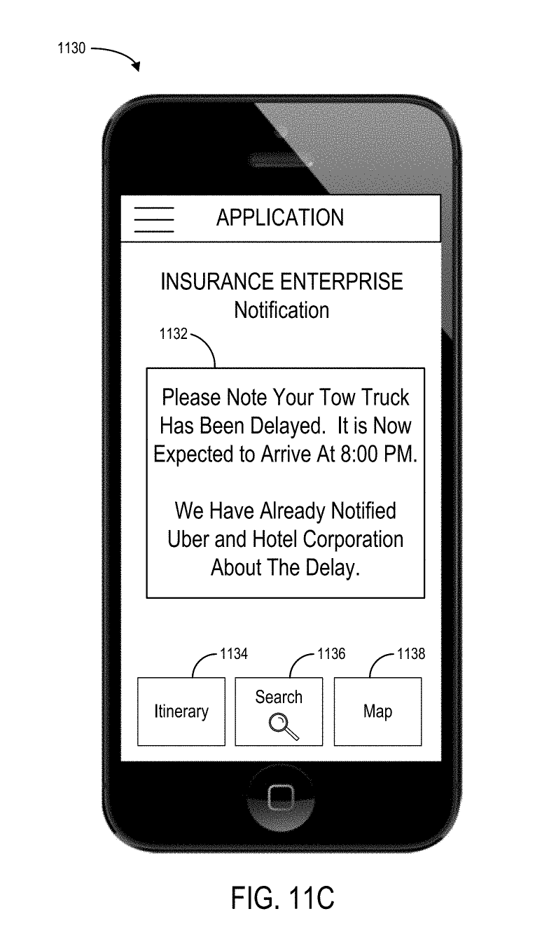

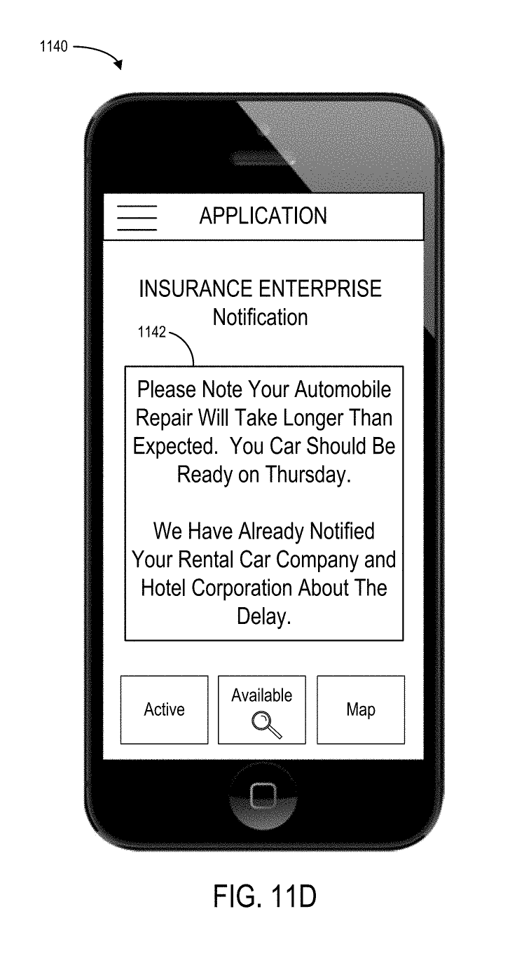

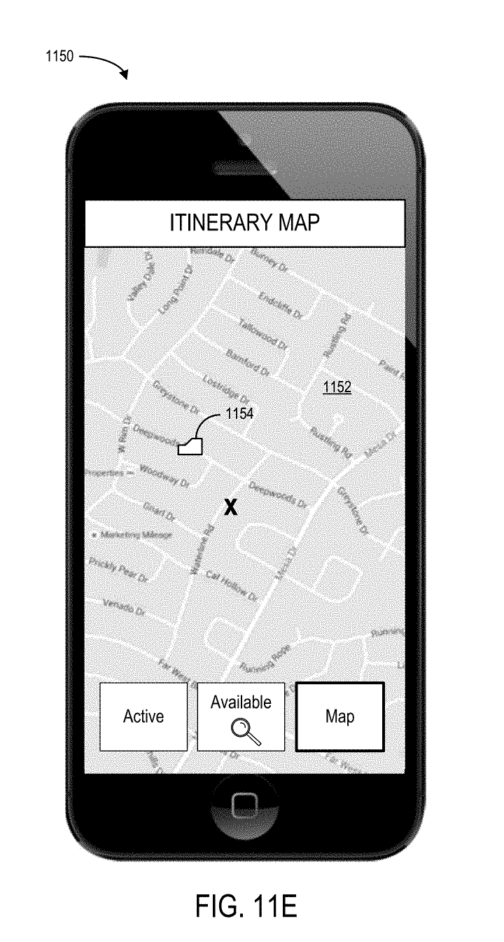

According to some embodiments, a back-end application computer server facilitates an exchange of electronic messages, via a distributed communication network, to support at least one interactive user interface display associated with the remote user mobile device (e.g., a user may sign into a smartphone application to report an event and/or view his or her itinerary). For example, FIGS. 11A through 11E illustrate smartphone user displays in accordance with some embodiments. The displays might be associated with, for example, a smartphone application with a login screen that a customer can use to enter his or her username and password to access an insurance enterprise system. When the customer's username and password are verified, he or she may use the application to report an event. For example, FIG. 11A illustrates a user display 1110 including user inputs 1112 that may be used to enter, for example, a drivability status, whether transit is needed, whether lodging is needed, whether a rental car is needed, a current location (which might also be automatically determined by the smartphone or enterprise system), etc.

The user inputs 1112 may be utilized by the enterprise system to automatically generate a set of action requests to be transmitted to service providers as illustrated in Table I.

TABLE I
Automatically Generated Action Requests

| Action Type | Action Description |
|---|---|
| CALL | Uber to location of tow drop |
| CALL | tow truck to wreck site |
| CALL | body shops for nearest open location |
| CALL | hotels nearby for reservation |
| CALL | rental service to reserve car nearby |

The automatically generated action requests may result in the creation of an itinerary for the customer. For example, FIG. 11B illustrates an itinerary display 1120 with details 1122 about the customer's tow service, body shop service, transportation service, hotel, etc. Note that some or all of the details 1122 might have been generated based on one or more user preferences. Moreover, the details 1122 might include user-selectable links (illustrated as underlined text in FIG. 11B) to facilitate communication with the service providers.

Note that a service provider might transmit an action request update to the enterprise system. For example, FIG. 11C illustrates a notification display 1130 that might be transmitted to a customer when a tow truck transmits an action request update indicating that the service will be delayed. The display 1130 includes notification details 1132 informing the customer that the tow service has been delayed and that the transportation service and hotel been automatically informed about the itinerary change. The display 1130 further includes an itinerary icon 1134 (to take the user to the display 11120 illustrated in FIG. 11B), a search icon 1136 (e.g., to search his or her itinerary, look for nearby restaurants, etc.), and a map icon (to take the user to a display as described with respect to FIG. 11E). Similarly, FIG. 11D illustrates a notification display 1140 with details 1142 informing the customer that the repair service has been delayed and that the automobile rental service and hotel been automatically informed about the itinerary change.

FIG. 11E illustrates an itinerary map display 1150 that might be provided to a customer in some embodiments. The display 1150 includes map information 1152 illustrating the customer's current location (e.g., where an event occurred as designated by an “X” on the map information 1152) along with the location of a service provider 1154 (e.g., so that the customer can verify that a tow truck or taxi is en route to his or her location).

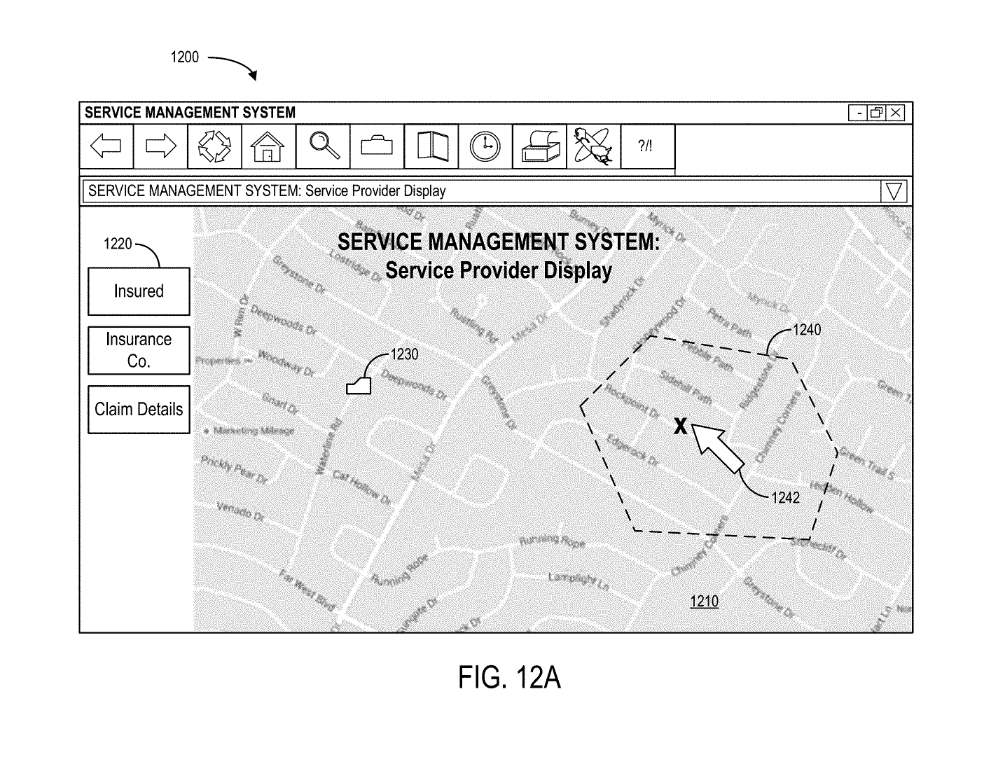

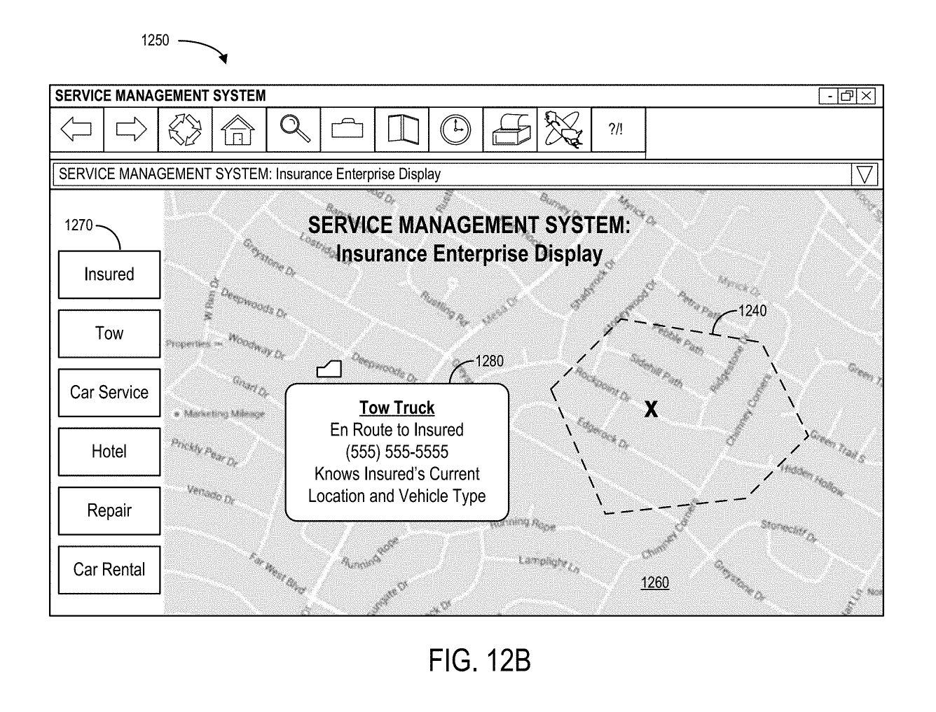

In addition to providing may information to a customer, in some embodiments map information may be provided to a service provider and/or an insurance enterprise. For example, FIG. 12A illustrates a service provider display 1200 that might be displayed via a web browser executing on a computer monitor according to some embodiments. The service provider display 1200 includes map information 1210 and icons 1220 that can be used to contact the insured, contact the insurance company, view or provide claim details, etc. The map information 1210 includes the location of the service provider 1230 (e.g., tow truck) and the customer (e.g., designated by an “X” on the map information 1210). The map information 1210 might also include a geographic region 1240 (e.g., a region 1240 defining when the service provider is five minutes away from the customer which could, in some embodiments, trigger an automatic phone call or text message to the customer). According to some embodiments, the service provider might select a display element via a touch screen or computer mouse pointer 1242 to receive more information about that element. When the service provider selects an icon 1220 to provide claim details, the display 1200 might be updated so that the service provider can add a text note, a voice-to-text note, and/or a photograph (e.g., captured with a smartphone camera). As another example, the display 1200 might support uploading, to a cloud-based application, video information, weather information (e.g., a temperature, noise level, wind speed, barometric pressure, etc.), and environmental quality information (e.g., air quality, water contamination, etc.).

Similarly, FIG. 12B illustrates an insurance enterprise display 1200 that might be displayed via a web browser executing on a computer monitor according to some embodiments. The insurance enterprise display 1200 includes map information 1260 and icons 1270 that can be used to contact the insured or service providers. The map information 1260 includes the location of one or more service providers, the customer, a geographic region 1240, etc. According to some embodiments, the service provider might select a display element via a touch screen or computer mouse pointer to receive more information 1280 about that element.

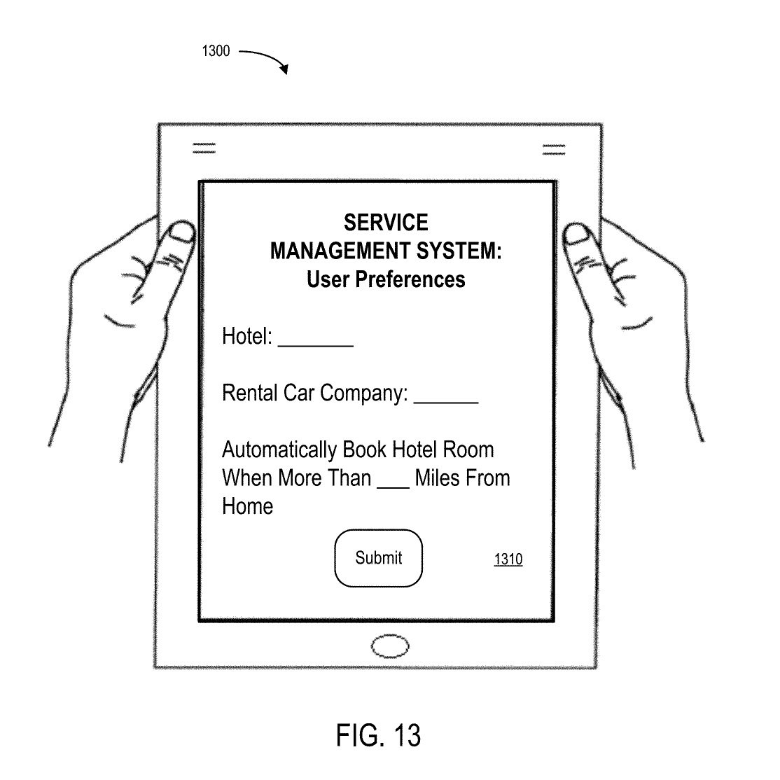

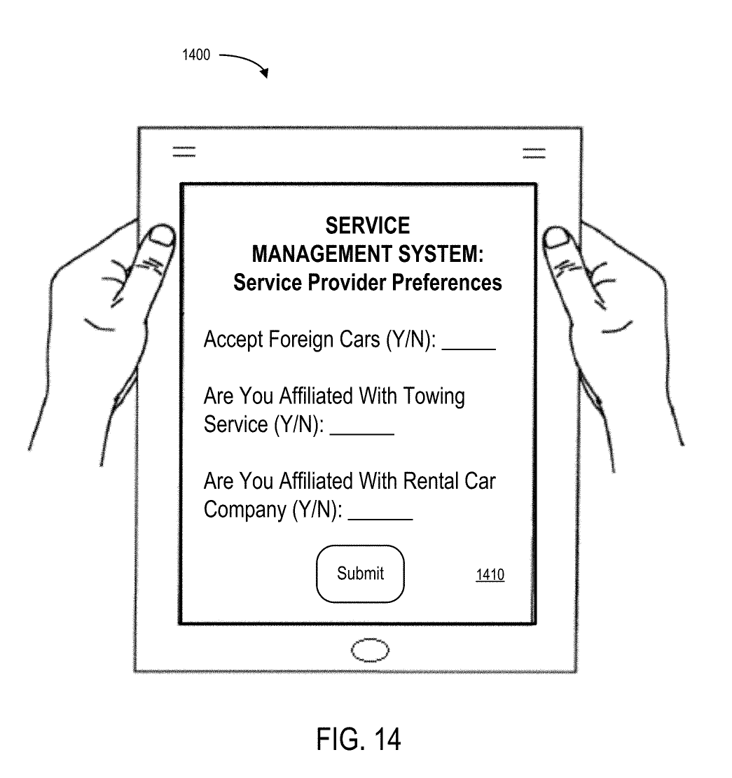

FIG. 13 illustrates a tablet user preferences display 1300 in accordance with some embodiments. In particular, the display 1300 includes an input area 1310 where a user can enter various preferences (e.g., a preferred hotel, a preferred car company, one or more logic based rules, etc.). A service management system may use these inputs when automatically creating action requests for the user. Similarly, FIG. 14 illustrates a tablet service provider preferences display 1400 in accordance with some embodiments. This display 1400 includes an input area 1410 where a service provider can enter various preferences (e.g., whether the service provider is affiliated with a specific towing service or rental car company, the types of repairs offered by an automobile repair shop, etc.).

FIG. 15 is a high level system interface architecture 1500 according to some embodiments. An enterprise coordination services platform 1550 may use rules and logic 1560 to communicate with a user device 1510, a service provider A device 1520, and a service provider B device 1530. The rules and logic 1560 might comprise, for example, a potential event/potential action table or coding that defines (and in some cases, sequentially ranks in time) the various types of services that should be provided in response to various types of events. The devices 1550, 1510, 1520, 1530 may communicate, for example, via digitized messages and a customized API (e.g., mapping combinations of inputs to outputs as appropriate). According to some embodiments, the enterprise coordination services platform 1550 transmits a modified action request to service provider. In some implementations, information about the modification might also be transmitted from the enterprise coordination services platform 1550 to the user device 1510. According to other embodiments, the information about the modification may instead be transmitted from the service provider A device 1520 to the user device 1510 (as illustrated by a dashed arrow in FIG. 15). Note that in some embodiments, service provider A device 1520 might communicate directly with service provider B device 1530 (e.g., without including the user device 1510 or the enterprise coordination services platform 1550). Note that, as used herein, the term “API” might refer to, for example, subroutine definitions, data format requirements, and/or tools that can be used to build application software. For example, an API for service providers might define methods of communication between various software components to provide building blocks that can be assembled by a programmer. Note that an API might be associated with a web-based system, an Operating System (“OS”), a database system, computer hardware, software library, etc. and may include various routines, data structures, object classes, variables, remote calls, etc.

According to some embodiments, the enterprise coordination services platform 1550 and the service provider devices 1520, 1530 may exchange information via a common service management API. According to other embodiments, different service provider devices 1520, 1530 might utilize different APIs (e.g., supporting different types of services). In this case, the enterprise coordination services platform 1550 might maintain a table indicating an appropriate API for each service provider device. When information is to be transmitted to (or is received from) a service provider device, the enterprise coordination services platform 1550 may search the table to determine an appropriate API and format (or interpret) action request data.

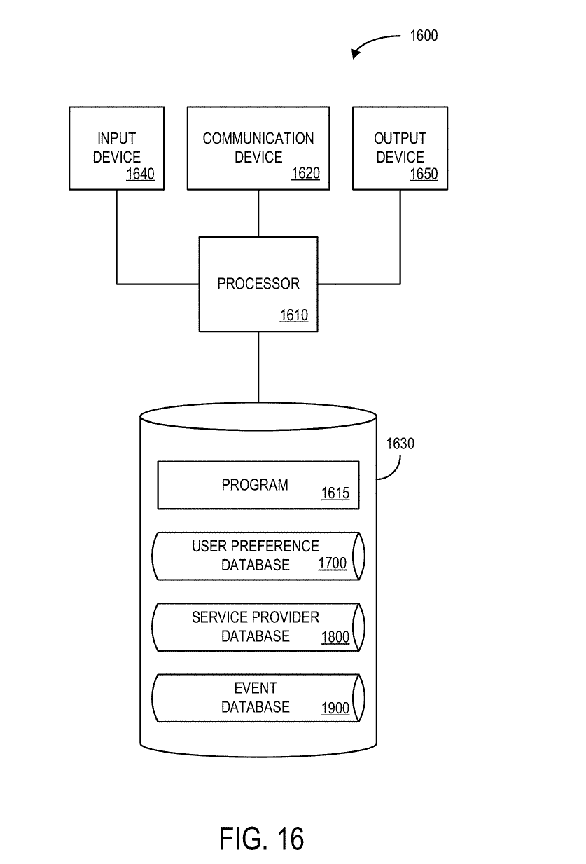

Embodiments described herein may comprise a tool that coordinates service provider actions and may be implemented using any number of different hardware configurations. For example, FIG. 16 illustrates a back-end application computer server 1600 that may be, for example, associated with the system 800 of FIG. 8A or the system 802 of FIG. 8B. The back-end application computer server 1600 comprises a processor 1610, such as one or more commercially available Central Processing Units (“CPUs”) in the form of one-chip microprocessors, coupled to a communication device 1620 configured to communicate via a communication network (not shown in FIG. 16). The communication device 1620 may be used to communicate, for example, with one or more remote user or service provider computers and/or communication devices (e.g., PCs and smartphones). Note that communications exchanged via the communication device 1620 may utilize security features, such as those between a public internet user and an internal network of an insurance enterprise. The security features might be associated with, for example, web servers, firewalls, and/or PCI infrastructure. The back-end application computer server 1600 further includes an input device 1640 (e.g., a mouse and/or keyboard to enter information about locations, service providers, rules and logic, etc.) and an output device 1650 (e.g., to output action requests, statuses, reports regarding system administration, etc.).

The processor 1610 also communicates with a storage device 1630. The storage device 1630 may comprise any appropriate information storage device, including combinations of magnetic storage devices (e.g., a hard disk drive), optical storage devices, mobile telephones, and/or semiconductor memory devices. The storage device 1630 stores a program 1615 and/or a dispatch tool or application for controlling the processor 1610. The processor 1610 performs instructions of the program 1615, and thereby operates in accordance with any of the embodiments described herein. For example, the processor 1610 may generate action requests for a service management system. In particular, the processor 1610 may receive, from a remote user mobile device, an indication associated with an event. The processor 1610 may then determine at least one location coordinate associated with the event and select a sub-set of service providers from a service provider data store based on the location and at least one user preference value. The processor 1610 may generate an action request for a designated one of the sub-set of service providers in accordance with logic based rules and transmit information about the action request to the designated service provider and the remote user mobile device. The processor 1610 may receive an action request update and transmit a modified action request to another service provider.

The program 1615 may be stored in a compressed, uncompiled and/or encrypted format. The program 1615 may furthermore include other program elements, such as an operating system, a database management system, and/or device drivers used by the processor 1610 to interface with peripheral devices.

As used herein, information may be “received” by or “transmitted” to, for example: (i) the back-end application computer server 1600 from another device; or (ii) a software application or module within the back-end application computer server 1600 from another software application, module, or any other source.

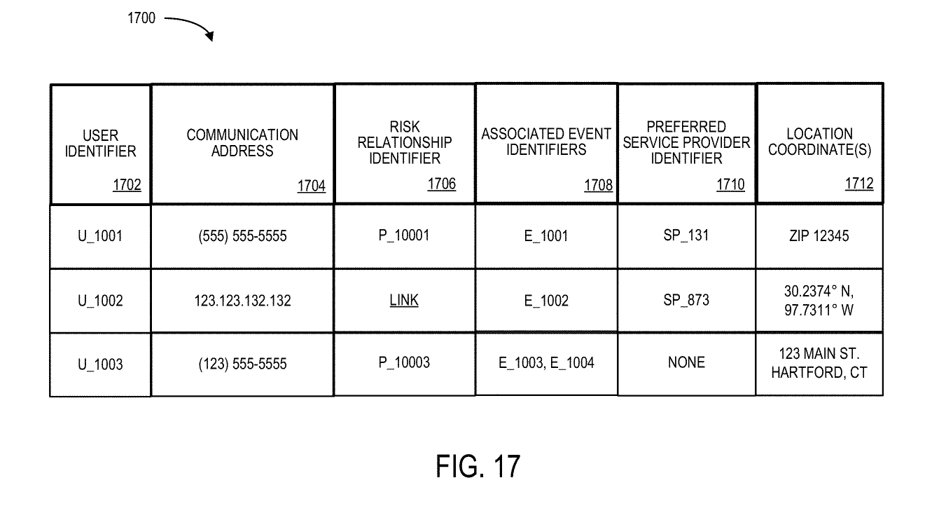

In some embodiments (such as shown in FIG. 16), the storage device 1630 further stores a user preference database 1700, a service provider database 1800, and an event database 1900. Examples of databases that might be used in connection with the back-end application computer server 1600 will now be described in detail with respect to FIGS. 17 through 19. Note that the databases described herein are only examples, and additional and/or different information may be stored therein. Moreover, various databases might be split or combined in accordance with any of the embodiments described herein. For example, the user preferences database 1700 and/or service provider database 1800 might be combined and/or linked to each other within the program 1615.

Referring to FIG. 17, a table is shown that represents the user preference database 1700 that may be stored at the back-end application computer server 1600 according to some embodiments. The table may include, for example, entries identifying users of an insurance enterprise. The table may also define fields 1702, 1704, 1706, 1708, 1710, 1712 for each of the entries. The fields 1702, 1704, 1706, 1708, 1710, 1712 may, according to some embodiments, specify: a user identifier 1702, a communication address 1704, a risk relationship identifier 1706, one or more associated event identifiers 1708, a preferred service provider identifier 1710, and one or more location coordinates 1712. The user preference database 1700 may be created and updated, for example, based on information electrically received from a user device (e.g., as described with respect to FIG. 13).

The user identifier 1702 may be, for example, a unique alphanumeric code identifying a user (e.g., an insured party who has been in an automobile accident). The communication address 1704 may be used to exchange information with the user (e.g., a smartphone number, IP address, etc.) The risk relationship identifier 1706 might comprise a unique alphanumeric code or link associated with an insurance policy. The event identifiers 1708 might comprise a unique alphanumeric code identifying an accident, insurance claim, etc. The preferred service provider identifier 1710 might comprise, for example, an automobile rental company or hotel chain that a user would prefer to utilize if possible. The one or more location coordinates 1712 might indicate where the user is currently located or where an event occurred (e.g., a ZIP code, street address, GPS data, etc.).

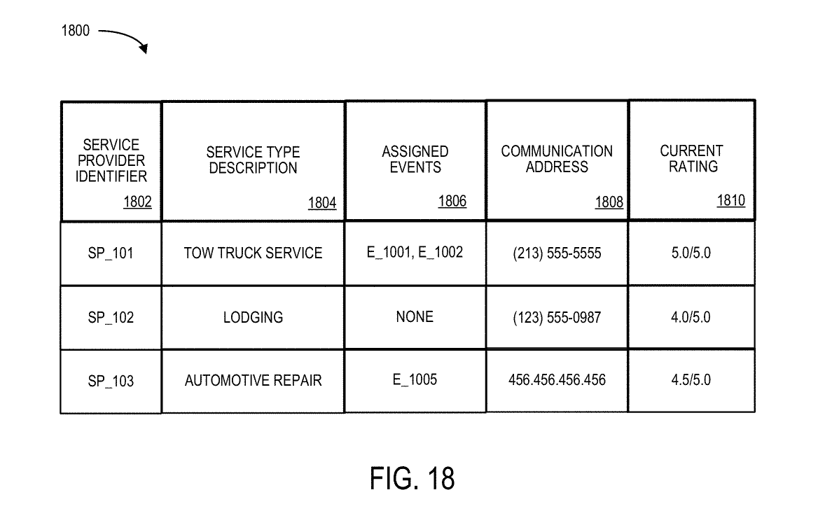

Referring to FIG. 18, a table is shown that represents the service provider database 1800 that may be stored at the back-end application computer server 1600 according to some embodiments. The table may include, for example, entries identifying service providers that can perform actions for users. The table may also define fields 1802, 1804, 1806, 1808, 1810 for each of the entries. The fields 1802, 1804, 1806, 1808, 1810 may, according to some embodiments, specify: a service provider identifier 1802, a service type description 1804, one or more assigned events 1806, a communication address 1808, and a current rating 1810. The service provider database 1800 may be created and updated, for example, based on information electrically received when an enterprise establishes a service network to respond to events.

The service provider identifier 1802 may be, for example, a unique alphanumeric code identifying a service provider (e.g., tow service, hotel, etc.) and might be based on or associated with the preferred service provider identifier 1710 in the user preference database 1700. The service type description 1804 may describe the service (e.g., a taxi service, a repair shop, etc.). The assigned events 1806 might be an alphanumeric code identifying an accident or insurance claim and might be based on or associated with the associated event identifiers 1708 in the user preferences database 1700. The communication address 1808 might indicate how the service provider should be contacted (e.g., to help a user identify the service provider when he or she arrives at an event location). The current rating 1812 might comprise, for example, an average satisfaction value representing a number of user reviews (e.g., over the last month).

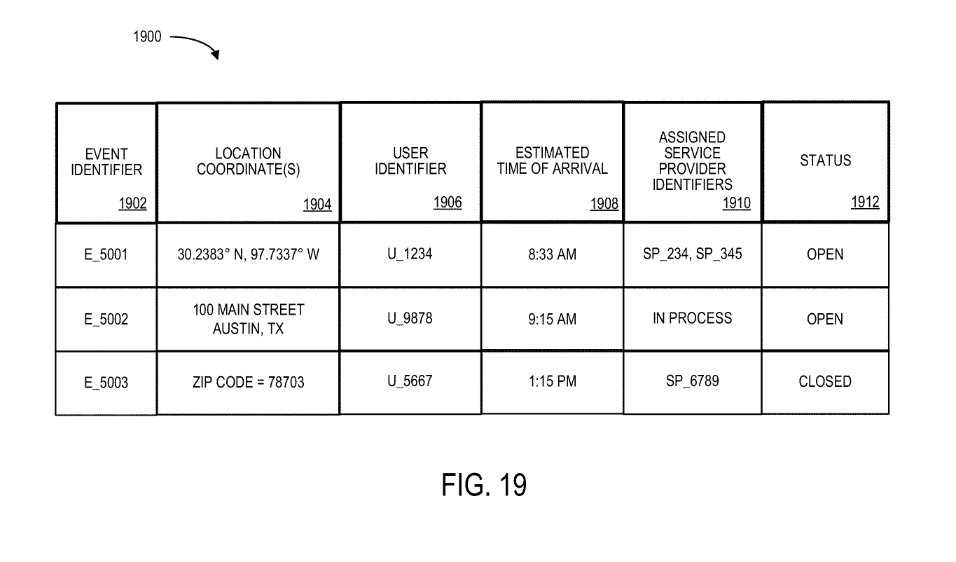

Referring to FIG. 19, a table is shown that represents the event database 1900 that may be stored at the back-end application computer server 1600 according to some embodiments. The table may include, for example, entries identifying accidents or insurance claims that have been reported by users. The table may also define fields 1902, 1904, 1906, 1908, 1910, 1912 for each of the entries. The fields 1902, 1904, 1906, 1908, 1910, 1912 may, according to some embodiments, specify: an event identifier 1902, one or more location coordinates 1904, a user identifier 1906, an estimated time of arrival 1908, assigned service provider identifiers 1910, and a status 1912. The event database 1900 may be created and updated, for example, based on information electrically received from user as they report events to an insurance enterprise.

The event identifier 1902 may be, for example, a unique alphanumeric code identifying an accident or insurance claim that has been reported to the system and might be based on or associated with the associated event identifiers 1708 in the user preference database 1700 and/or the assigned events 1806 in the service provider database 1800. The location coordinates 1904 might indicate where a user is currently located or where an event occurred. The user identifier 1906 may be, for example, a unique alphanumeric code identifying user and might be based on or associated with the associated user identifiers 1702 in the user preference database 1700. The estimated time of arrival 1908 might be a prediction of when a service provider will most likely arrive at the claim location. The assigned service provider identifiers 1910 may be, for example, a unique alphanumeric code identifying service providers and might be based on or associated with the preferred service provider identifiers 1710 in the user preference database 1700 and/or the service provider identifier 1802 in the service provider database 1800. The status 1912 might indicate that the insurance claim associated with an event is open, assigned, in process, closed, etc.

Thus, embodiments may provide an automated and efficient way to coordinate actions performed by service providers in response to an event. As a result, the quality of service given to a user may be improved (e.g., the services might be performed faster, be less likely to result in mistakes or miscommunications, etc.).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Some embodiments have been described herein in connection with an automobile insurance policy (with the location of the insurance claim being the location of an accident). Note, however, that embodiments may be associated with other types of insurance, including homeowner's insurance, property insurance, etc. In the case of homeowner's insurance, an insurance claim's “location” might be the user's home address.

Although specific hardware and data configurations have been described herein, note that any number of other configurations may be provided in accordance with embodiments of the present invention (e.g., some of the information associated with the displays described herein might be implemented as a windshield display or a virtual or augmented reality display and/or any of the embodiments might be implemented using a cloud based computing platform). Moreover, although embodiments have been described with respect to particular types of communication addresses, embodiments may instead be associated with other types of communications (e.g., chat implementations, web-based messaging, etc.). Still further, the displays and devices illustrated herein are only provided as examples, and embodiments may be associated with any other types of user interfaces.

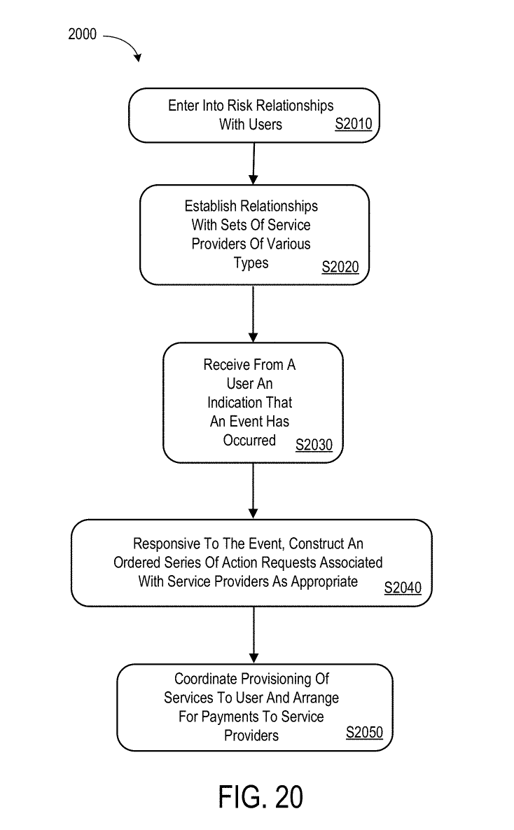

Note that embodiments described herein might be used in connection with a number of different types of enterprise process flows. For example, FIG. 20 illustrates an overall process 2000 in accordance with some embodiments. At S2010, an enterprise may enter into risk relationships with users. For example, an insurance enterprise may sell automobile insurance policies to users. At S2020, the enterprise may establish relationships with sets of service providers of various types. For example, an insurance company may arrange for groups of towing services, repair shops, taxi fleets, hotel chains, medical offices (e.g., when an injured user needs to visit a doctor), emergency rooms, etc. to provide services (e.g., perform actions) for users who have automobile accidents. At S2030, the enterprise may receive from a user an indication that an event has occurred. For example, the user might place a telephone call to the insurance enterprise or use an application executing on his or smartphone to report an automobile accident. Responsive to occurrence of the event, at S2040 the system may construct an ordered series of action requests associated with service providers as appropriate. For example, the ordered series of action requests might include a first action request for a tow service to transport the user's car to a repair shop, a second action request for the repair shop to fix the automobile, a third action request for a taxi to transport the user from the site of the accident to a particular hotel, etc. At S2050, the insurance claim may be resolved (that is, the automobile may be repaired), payments may be transmitted to various service providers as appropriate, and the system may evaluate results (e.g., costs), user supplied ratings, and/or algorithms (e.g., on a periodic basis to determine if the algorithms may be improved to provide better service for users).

In some cases, an enterprise might want to securely record various transactions associated with a coordination of services for a user, including payments made to service providers. FIG. 21 is an example of a “blockchain” embodiment 2100 according to some embodiments. As used herein, the term “blockchain” may refer to any distributed ledger or database that maintains a growing list of ordered records (or blocks), associated timestamps, and links to previous blocks. Because the data is stored in an integrated and distributed fashion, blockchains are secure (once recorded, a block cannot be retroactively changed or tampered with). As illustrated in FIG. 21, the blockchain embodiment 2100 may include cloud based coordination services 2110, individual blockchains 2120, at least one coordination server 2130, and one or more service providers 2140. In this way, at least one of an action request, an action request update, a modified action request, or a payment transaction may be secured by a back-end application computer server via a blockchain verification process. According to some embodiments, additional blockchains 2122, additional coordination services 2132, and/or additional service providers 2142 may also be provided (e.g. to further distribute the ledger). The use of blockchains 2100 may further be utilized by a secure audit process (e.g., to accurately determine what services were provided, when those services were performed, etc.).

According to some embodiments, a transaction may further be associated with rules, logic, and/or other conditions that are automatically implemented via individual blockchains 2120. For example, a blockchain 2120 might be associated with a “smart contract” that is partially or fully executed and enforced without human interaction. Note that a blockchain 2120 might include coding that executes when specified conditions are met (e.g., when a particular type of service is provided). For example, a blockchain smart contract might be enabled by extensible programming instructions that define and execute an agreement that a particular service will cost no more than a pre-determined threshold amount, will be performed with a pre-determined time period, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to automatically generate action requests for a service management system via an automated back-end application computer server, comprising:
(a) a user preference data store containing electronic records associated with a set of users, including, for each user, a user identifier, a user communication address, a risk relationship identifier, and at least one user preference value;
(b) a service provider data store containing electronic records associated with a set of service providers, including, for each service provider, a service provider identifier and a service provider communication address;
(c) the back-end application computer server, coupled to the user preference and service provider data stores, programmed to:
(i) receive, from a remote user mobile device associated with a user, an indication associated with an occurrence of an event,
(ii) automatically determine at least one location coordinate associated with the occurrence of the event,
(iii) automatically select a sub-set of service providers from the service provider data store based on the location of the event and at least one user preference value in the user preference data store,
(iv) automatically generate an action request for a designated one of the sub-set of service providers in accordance with logic based rules, the action request being formatted in accordance with an application programming interface protocol,
(v) transmit information about the action request to the designated service provider via the application programming interface and to the remote user mobile device,
(vi) receive an action request update from the designated service provider, and
(vii) responsive to the action request update, automatically generate and transmit a modified action request to another service provider in the selected sub-set of service providers; and
(d) a communication port coupled to the back-end application computer server to facilitate an exchange of electronic messages, via a distributed communication network, supporting at least one interactive user interface display associated with the remote user mobile device.

2. The system of claim 1, wherein receipt of the action request update cascades to create multiple modified action requests that are transmitted to multiple service providers.

3. The system of claim 1, wherein at least one user preference value is associated with at least one of: (i) a preferred service provider type, (ii) a preferred response to an event, (iii) historical user data associated with the user, and (iv) historical user data associated with other users.

4. The system of claim 1, wherein the service provider data store further stores, for each service provider, at least one service provider preference value and the selection of the sub-set of service providers is further based on service provider preference values.

5. The system of claim 1, wherein the designated service provider is selected by the user from the sub-set of service providers.

6. The system of claim 1, wherein the user communication address is associated with at least one of: (i) a mobile telephone number, (ii) a vehicle identifier, (iii) a user identifier, (iv) an Internet Protocol address, and (v) a device identifier associated with a push message registration.

7. The system of claim 1, wherein the location coordinate is associated with at least one of: (i) a postal address, (ii) a ZIP code, (iii) Global Positioning System information, (iv) latitude and longitude values, and (v) mobile telephone location data.

8. The system of claim 1, wherein the selected sub-set of service providers is calculated using at least one of: (i) distance information, (ii) time information, (iii) traffic information, (iv) weather information, (v) speed limit information, (vi) jurisdiction information, and (vii) current service provider location information.

9. The system of claim 1, wherein the back-end application computer server is further programmed to interface with a user's calendar application and to calculate an estimated time in connection with at least one service provider.

10. The system of claim 1, wherein at least one of the action request, the action request update, the modified action request, and a payment transaction is secured by the back-end application computer server via a blockchain verification process.

11. The system of claim 1, wherein the risk relationship identifiers are associated with insurance policies, the interactive user interface display is associated with an application executing on an insured's smartphone and includes a map containing icons representing service providers assigned to the insurance claim.

12. The system of claim 11, wherein selection of an icon results in a display of detailed information about that service provider, and at least one of the service providers is associated with: (i) automobile towing, (ii) automobile repair, (iii) a transportation service, (iv) a dynamic, on-demand transportation platform, (v) a transportation sharing service, (vi) automobile rental, and (vii) lodging.

13. The system of claim 11, wherein the back-end application computer server is further programmed to receive, from at least one service provider device, insurance claim information including at least one of: (i) text comprising insurance claim notes, (ii) images, (iii) audio information, (iv) video information, (v) environmental quality information, and (vi) weather information.

14. The system of claim 11, wherein information about events is dynamically collected via at least one of: (i) an email received by an email server, (ii) information provided a web interface, (iii) an interactive voice response system associated with a telephone call center, (iv) a chat application that interacts with a party in substantially real time, and (v) a video link.

15. The system of claim 1, wherein the back-end application computer server is further programmed to receive from the user rating information about at least one service provider.

16. The system of claim 1, wherein the back-end application computer server is further programmed to periodically monitor performance outcomes and automatically adjust a prioritization algorithm used to select the sub-set of service providers.

17. The system of claim 1, wherein the remote user mobile device is associated with: (i) a smartphone, (ii) a mobile computer, (iii) a tablet computer, (iv) an on-board vehicle diagnosis plug-in device, (v) a built-in dashboard display, (vi) a flying drone, (vii) a self-driving vehicle, (viii) a smart watch, (ix) a pair of smart eyeglasses, (x) an augmented reality device, (xi) an Internet of Things (“IoT”) device, (xii) a health monitoring device, and (xiii) a network-connected device able to approximate and report a current location.

18. A computerized method to automatically generate action requests for a service management system via an automated back-end application computer server, comprising:
receiving, at the back-end application computer server from a remote user mobile device associated with a user, an indication associated with an occurrence of an event;
automatically determining at least one location coordinate associated with the occurrence of the event;
automatically selecting a sub-set of service providers from a service provider data store based on the location of the event and at least one user preference value in the user preference data store, wherein the user preference data store contains electronic records associated with a set of users, including, for each user, a user identifier, a user communication address, a risk relationship identifier, and at least one user preference value, and the service provider data store contains electronic records associated with a set of service providers, including, for each service provider, a service provider identifier and a service provider communication address;
generating an action request for a designated one of the sub-set of service providers in accordance with logic based rules;
transmitting information about the action request to the designated service provider and the remote user mobile device;
receiving an action request update from the designated service provider; and
responsive to the action request update, automatically generating and transmitting a modified action request to another service provider in the selected sub-set of service providers,
wherein the back-end application computer server facilitates an exchange of electronic messages, via a distributed communication network, supporting at least one interactive user interface display associated with the remote user mobile device.

19. The method of claim 18, wherein receipt of the action request update cascades to create multiple modified action requests that are transmitted to multiple service providers.

20. A system to automatically generate action requests for a service management system via an automated back-end application computer server, comprising:
(a) a user preference data store containing electronic records associated with a set of users, including, for each user, a user identifier, a user communication address, a risk relationship identifier, and at least one user preference value;
(b) a service provider data store containing electronic records associated with a set of service providers, including, for each service provider, a service provider identifier and a service provider communication address;
(c) the back-end application computer server, coupled to the user preference and service provider data stores, programmed to:
(i) receive, from a remote user mobile device associated with a user, an indication associated with an occurrence of an event,
(ii) automatically determine at least one location coordinate associated with the occurrence of the event,
(iii) automatically select a sub-set of service providers from the service provider data store based on the location of the event and at least one user preference value in the user preference data store,
(iv) generate an action request for a designated one of the sub-set of service providers in accordance with logic based rules,
(v) transmit information about the action request to the designated service provider and the remote user mobile device,
(vi) receive an action request update from the designated service provider, and
(vii) responsive to the action request update, automatically generate and transmit a modified action request to another service provider in the selected sub-set of service providers; and
(d) a communication port coupled to the back-end application computer server to facilitate an exchange of electronic messages, via a distributed communication network, supporting at least one interactive user interface display associated with the remote user mobile device.

21. The system of claim 20, wherein receipt of the action request update cascades to create multiple modified action requests that are transmitted to multiple service providers.
